(19) United States
(12) Patent Application Publication
(10) Pub. No.: US 2003/0181211 A1
(43) Pub. Date: Sep. 25, 2003

(54) Method and apparatus for dynamic channel selection in wireless modems

(76) Inventors: Javad Razavilar, San Diego, CA (US); Neeraj Poojary, San Diego, CA (US); Dennis P. Connors, San Diego, CA (US); James A. Crawford, San Diego, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/101,891

(22) Filed: Mar. 19, 2002

(51) Int. Cl. H04Q 7/20

(52) U.S. Cl. 455/450; 455/509; 455/513

(57) ABSTRACT

A dynamic channel selection algorithm for a communication system including the steps of determining a channel metric indicative of a level of interference for a plurality of available channels; sorting the plurality of available channels according to their channel metrics; determining whether co-channel signaling is present on a available channel having a lowest channel metric; and selecting one of the available channels based upon whether the co-channel signaling is present on the available channel having the lowest channel metric. In variations, selection of an available channel is based upon whether co-channel signaling is present on available channels other than the available channel having a lower channel metric, and a difference between channel metrics of the available channel having the lowest channel metric and available channels having higher channel metrics.

### METHOD AND APPARATUS FOR DYNAMIC CHANNEL SELECTION IN WIRELESS MODEMS

This application is related to U.S. patent application Ser. No. ______, Attorney Docket No. 71774, of Razavilar, et al., entitled METHOD AND APPARATUS FOR DYNAMIC CHANNEL SELECTION IN WIRELESS MODEMS HAVING MULTIPLE RECEIVE ANTENNAS, filed herewith, which is incorporated herein by reference.

### BACKGROUND OF THE INVENTION

1. Field of the Invention

The present invention relates generally to the selection of channels for communication in a communication system, and more specifically to the selection of channels based on measurements of received signal strength on a number of available channels.

2. Discussion of the Related Art

In many communications systems, communicating terminals may select one of several available channels in the operating band over which to communicate. In such systems, it is advantageous to have communications take place over an available channel having a relatively low level of interference so as to reduce potential adverse effects, e.g., reduced SIR for the desired user or receiver. Co-channel interference and adjacent channel interference are components of interference that degrade performance in a wireless link.

Systems have been devised to select, for communications, one of the multiple available channels that has a relatively low overall interference level in comparison to other available channels. In one such system, received signal strength measurements are taken at an antenna of a receiver in order to produce a histogram of the received signal strength for each available channel. The histogram (which is based on the magnitude of the interference level) is then used to select a desired available channel.

Furthermore, in many systems, e.g., synchronous media access control (MAC) systems, a signal or communication burst is transmitted from a transmitter to a receiver in which only 10% of the time the channel is utilized for transmitting the beacon. Thus, using the histogram-based method, 90% of the time the received signal strength measurements taken are noise floor measurements. As a result, measurements of a particular available channel's received signal strength are often inaccurate because 90% of the time only the noise floor is seen on the available channel.

### SUMMARY OF THE INVENTION

The present invention advantageously addresses the needs above as well as other needs by providing a dynamic channel selection algorithm in a communication system for selecting an available channel for use out of multiple available channels.

In one embodiment, the invention can be characterized as a method, and means for accomplishing the method, of selecting between available channels, the method including the steps of: determining a channel metric corresponding to measurements taken at a receiver for each of a plurality of available channels, the channel metric indicative of a level of interference in each of the plurality of available channels; sorting the plurality of available channels according to their respective channel metric; determining whether co-channel signaling is present on an available channel having a lowest channel metric of the plurality of available channels; and selecting one of the plurality of available channels based upon at least the determining whether the co-channel signaling is present on the available channel having the lowest channel metric.

In another embodiment, the invention can be characterized as a channel selection device for a communication terminal of a communication system comprising a dynamic selection module configured to perform the following steps: determining a channel metric corresponding to measurements taken at a receiver for each of a plurality of available channels, the channel metric indicative of a level of interference in each of the plurality of available channels; sorting the plurality of available channels according to their respective channel metric; obtaining an indication whether co-channel signaling is present on an available channel having a lowest channel metric of the plurality of available channels; and selecting one of the plurality of available channels based upon at least the determining whether the co-channel signaling is present on the available channel having the lowest channel metric.

In a further embodiment, the invention may be characterized as a method for selecting between available channels, the method including the steps of: receiving a plurality of received signal strength measurements corresponding to L discrete received signal strength measurements taken at an antenna within a time period of a measurement window for each of a plurality of available channels; retaining a quantity of M of the plurality of received signal strength measurements for each of the plurality of available channels, wherein the quantity M is a value up to 25% of L; and assigning a channel metric denoted by mᵢ to each of the plurality of available channels equal to:

$${m}_{i} = \frac{1}{M} {\sum }_{j = 1}^{M} ARRSI [ j ] i = 1 , 2 , … , I$$

where ARRSI[j] is one of the M received signal strength measurements, j is a received signal strength measurement index, i is an available channel index, and where i=1,2,3 . . . I, where I is a quantity of the plurality of available channels.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a diagram illustrating interference between communicating terminals of adjacent cells of a communication system;

FIG. 2 is a diagram illustrating adjacent channel interference between the communicating terminals of the adjacent cells of the communication system of FIG. 1.

FIG. 3A is a functional block diagram of several components of a receiver of a communication terminal, e.g., an access point of FIG. 1, which according to several embodiments of the invention, implements a dynamic channel selection algorithm for selecting one of many available channels for communications with other communication terminals;

FIG. 3B is a functional block diagram of several components of another embodiment of the receiver of FIG. 3A which according to several other embodiments of the invention, implements the dynamic channel selection algorithm for selecting one of many available channels for communications with other communication terminals;

FIG. 4 is a flowchart illustrating one embodiment of the steps of the dynamic channel selection algorithm which may be performed by the receiver of FIG. 3A or FIG. 3B;

FIG. 5 is a flowchart illustrating another embodiment of the steps of the dynamic channel selection algorithm of another embodiment of the invention;

FIG. 6 is a diagram illustrating interference between adjacent communication cells in which each access point in a communication cell has multiple receive antennas.

FIG. 7A is a functional block diagram of several components of a multi-antenna receiver of a communication terminal, e.g., an access point of FIG. 6, which according to several embodiments of the invention, implements a dynamic channel selection algorithm for selecting one of many available channels for communications with other communication terminals;

FIG. 7B is a functional block diagram of several components of another embodiment of the receiver of FIG. 7A which according to several embodiments of the invention, implements the dynamic channel selection algorithm for selecting one of many available channels for communications with other communication terminals;

FIG. 8 is a flowchart illustrating one embodiment of the steps of the dynamic channel selection algorithm which may be performed by the receiver of FIG. 7A or FIG. 7B for communications between various remote terminals and the access point; and

FIG. 9 is a flowchart illustrating another embodiment of the steps performed by the receiver of FIG. 7A or FIG. 7B when implementing the dynamic channel selection algorithm of another embodiment of the invention.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

Referring first to FIG. 1, a diagram is shown illustrating interference between communicating terminals of adjacent communication cells. Illustrated are two cells 102 and 104, cell 102 including access point 1 (AP1), and cell 104 including access point 2 (AP2). AP1 communicates with remote terminal 1 (RT1) in cell 102, while in cell 104, AP2 communicates with remote terminal (RT2).

Each access point, AP1 and AP2 may potentially use the same channel (for example, the same frequency channel, time channel and/or code channel) or adjacent channels for uplink and downlink transmissions. Each of the cells 102, 104, for example, may comprise communication cells in a wireless indoor network or a terrestrial cellular network. Focusing on the activity within cell 102, let AP1-RT1 denote a desired transmitter-receiver pair. Furthermore, in one embodiment, AP1 and RT1 transmit packets using a Time Division Multiple Access/Time Division Duplex (TDMA/TDD) scheme within cell 102; however, in other embodiments, AP1 and RT1 may communicate using any known multiplexing scheme. As is illustrated by arrows 106 and 108, AP2 and RT2 in cell 104 cause interference during downlink/uplink transmissions of the terminals in cell 102. For example, AP2 potentially causes interference 108 during its downlink transmission 112 destined for RT2 on communications 110 between AP1 and RT1. Also RT2 potentially causes interference 106 on the communications 110 in cell 102 during its uplink transmissions 114 destined for AP2. This interference, illustrated as arrows 106 and 108 may be either co-channel interference or adjacent channel interference. The interference 106, 108 is a large source of impairment that degrades performance in the wireless links of cell 102. Interference is especially problematic in a dense deployment environment, such as illustrated, where adjacent cells are in close proximity.

In general, there are two major sources for channel impairment, namely, adjacent channel interference (ACI) and co-channel interference (CCI). ACI is due, at least in part, to energy leakage from a signal transmitted in a channel adjacent to a channel selected by the AP. CCI, on the other hand, is due to in-band energy received from another transmitter, e.g. another AP or RT, in the vicinity using, for example, the same frequency channel, time channel (e.g., TDMA channel) and/or code channel (e.g., CDMA channel) for its operation.

According to several embodiments of the invention, a dynamic channel selection (DCS) algorithm is provided at a given communication terminal (e.g. AP1) to select, for communications, a channel from available channels based upon received signal strength measurements representing both the magnitude of interference (i.e., the magnitude of both ACI and CCI added together) and the types of interference present on the available channel (i.e., whether the interference is made up of ACI, CCI or both). Thus, in several embodiments, the DCS algorithm's channel selection criteria is based upon not only the level of interference, but also the make up of the interference on each available channel.

In preferred embodiments, the cells 102, 104 of FIG. 1 represent a wireless indoor (or indoor/outdoor) local area network using orthogonal frequency divisional multiplexed (OFDM) communications based on the IEEE 802.11a standard or the HiperLAN2 standard. However, it is noted that the dynamic channel selection algorithms of several embodiments of the invention may be applied in communication systems utilizing any single carrier or a multicarrier (one example of which is OFDM) transmission scheme. In some embodiments, the cells 102, 104 represent residential wireless networks in which the access points are to other computer networks, for example, a cable interface or a satellite interface to an Internet (e.g., within a set-top box), while the remote terminals comprise computers (PCs), laptops, televisions, stereos, appliances, palm devices, appliances, etc. In other embodiments, the cells 102, 104 represent wireless local area networks in an office or business in which the access points are coupled to larger computer networks and the remote terminals comprise other computers, laptops, palm devices, televisions, appliances, etc. In other embodiments, the cells 102, 104 represent wireless terrestrial cellular networks in which the access points comprise base stations and the remote terminals comprise wireless mobile devices. It is noted that in many embodiments, many of the communicating terminals are mobile. It is understood that the dynamic channel selection algorithm of several embodiments of the invention may apply to any wireless communication network, e.g., cellular, satellite, optical, short range, long range, indoor/outdoor, in which interference is present and/or channel conditions vary or fluctuate.

It is noted that that the Dynamic Channel Selection (DCS) algorithm as disclosed herein may be applied to select a desirable channel regardless of the type of channel a communication system operates under. For example, in several embodiments, the DCS algorithm is utilized to select an available frequency channel in communication systems that have multiple available frequency channels for communications (e.g., in an OFDM system). In several other embodiments, the DCS algorithm is utilized to select an available time channel (or time slot) in communications systems that have several available time channels to select from (e.g., in TDMA systems). In yet several other embodiments, the DCS algorithm is utilized to select an available code channel in communication systems that have multiple available code channels to select from (e.g., in CDMA systems). Thus, as used herein, the term channel generically refers to frequency channels, time channels, code channels, etc.

It is also noted that in many embodiments of the invention, one or more of the remote terminals within each cell support communications having different QoS requirements, i.e., one or more of the remote terminals support different types of traffic, such that the different communications have different requirements in terms of the signal-to-interference ratio (SIR) or signal-to-noise ratio (SNR) required to be achieved at the receiver. For example, each of the remote terminals RT1 and RT2 supports one or more of data, voice, and video traffic, for example.

It is also understood that the channel selection algorithm of several embodiments of the invention may be used between any two communicating devices, without requiring that such devices be a part of a network or a cell. Thus, the channel selection algorithm may be used in any system having two transceivers.

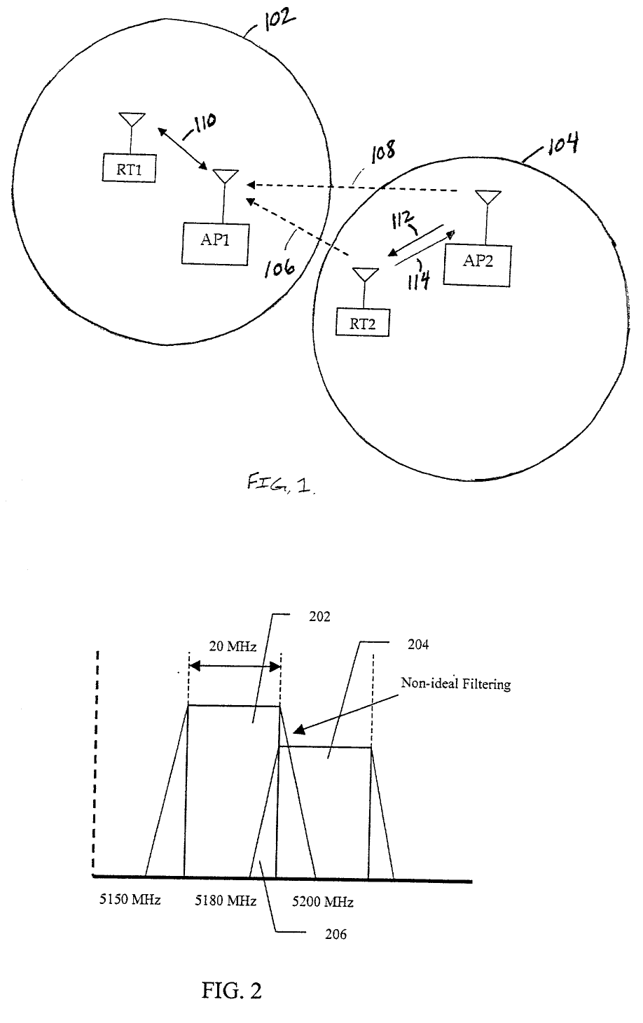

Referring next to FIG. 2, shown is energy leakage 206 from an adjacent frequency channel 204 into a desired frequency channel 202. This leakage 206 is often due to usage of non-ideal RF filters at a receiver input after reception by an antenna. Reducing this leakage 206 is often prohibitively expensive because sharp (high order) analog RF filters used to prevent the leakage 206 are expensive to build. The leakage 206 illustrated in FIG. 2 is typical of ACI that results from non-ideal RF analog filtering.

A Physical (PHY) layer specification of each communication standard defines the maximum acceptable adjacent channel interference level. For example, the IEEE 802.11a PHY specification requires that for Binary Phase Shift Keying (BPSK) mode, an adjacent channel interferer with a signal level of maximum 16 dB stronger, should cause no more than 10% packet error rate. This means that the signal level in a desired available channel should be no less than 16 dB weaker than the adjacent channel signal. For HiperLan2 PHY specifications, this limit is 20 dB, i.e., even if the signal level in the desired band is 20 dB weaker than the adjacent channel signal, the packet error rate should not be more than 10%.

To avoid the high costs of building sharp RF analog filters at high frequencies, it is customary to use RF filters with larger stop-bands and use high order digital filters at the baseband frequency to remove most of the remaining ACI.

While much of the ACI may be filtered out during baseband processing, it should be emphasized that CCI is difficult, if not practically impossible, to reduce by means of baseband processing. Therefore, with respect to interference effects upon a communication system, CCI is generally more problematic than ACI. As a result, an available channel having a lower magnitude of interference comprising CCI may be less desirable for communications than an available channel having a greater magnitude of interference consisting of ACI since much of the ACI may be filtered out in baseband processing. Thus, this factor should be taken into account as part of the basis for selecting an available channel during the dynamic selection (DCS) process.

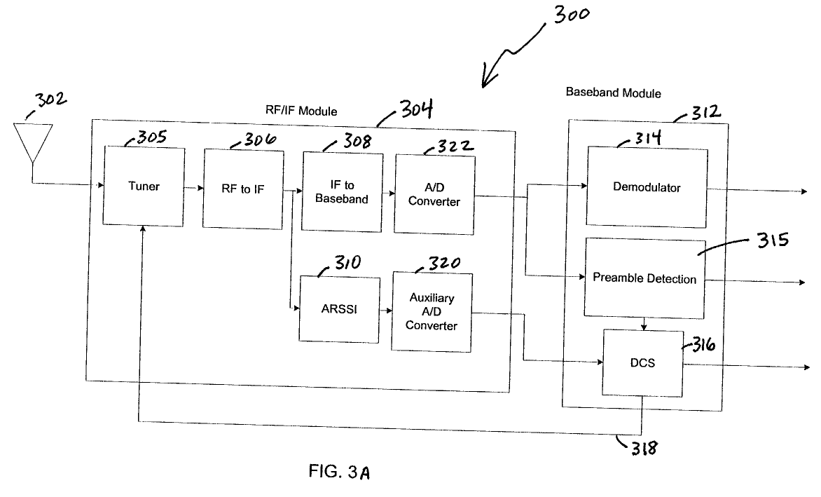

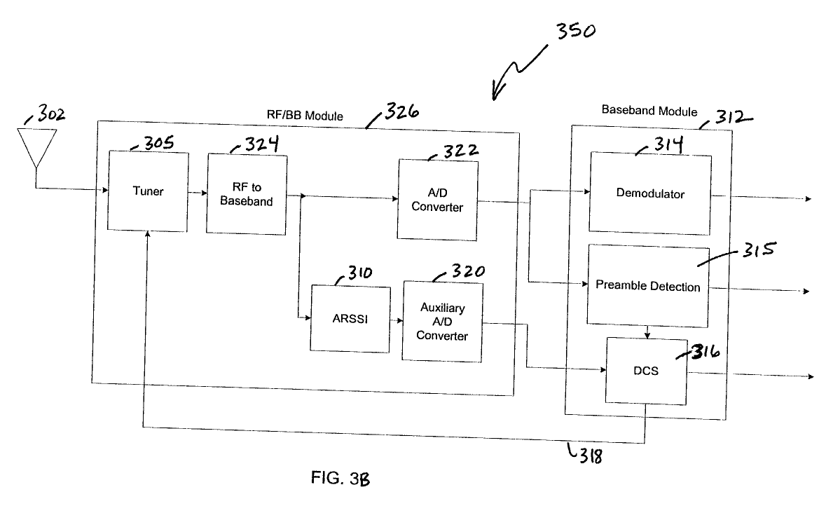

Referring next to FIG. 3A, is a functional block diagram of several components of a receiver 300 of a communication terminal, e.g., an access point of FIG. 1, which according to several embodiments of the invention, implements a dynamic channel selection algorithm for selecting one of many available channels for communications with other communication terminals.

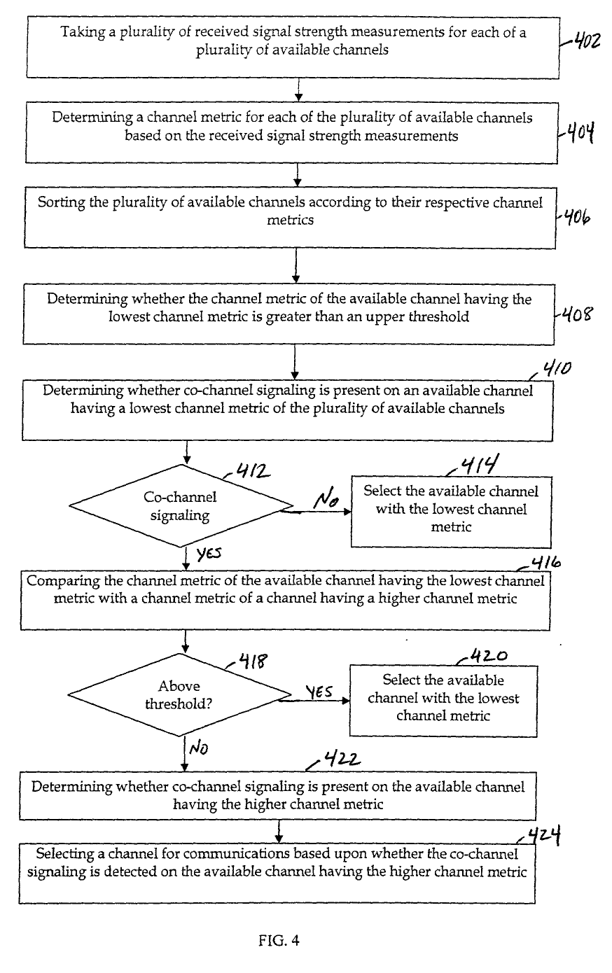

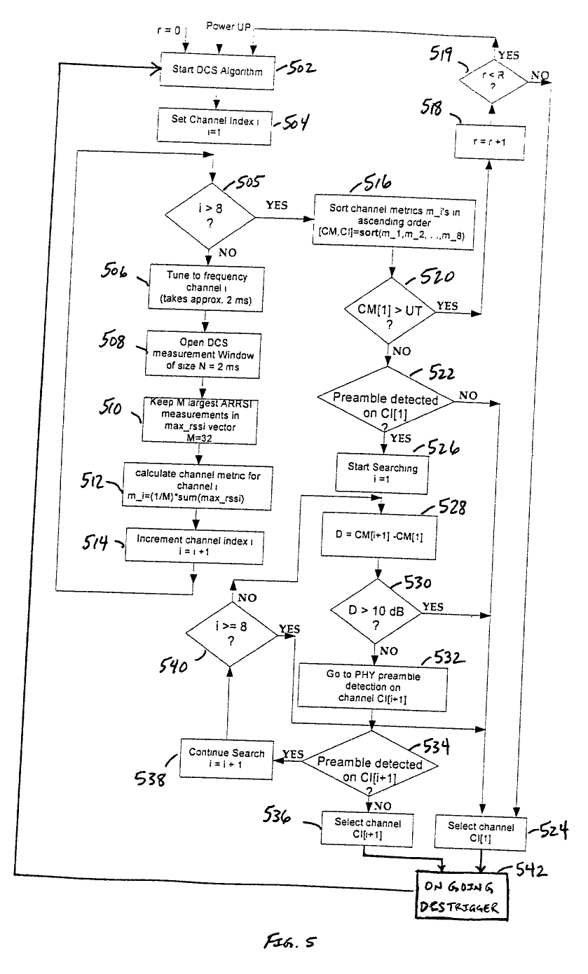

While referring to FIG. 3A, concurrent reference will be made to FIG. 4, which is a flowchart illustrating one embodiment of the steps of the dynamic channel selection algorithm which may be performed by the receiver of FIG. 3A or FIG. 3B.

Shown is the receiver 300 including an antenna 302, a radio frequency/intermediate frequency integrated circuit device 304 (hereinafter referred to as the RF/IF IC device 304) that comprises a tuner 305, a radio frequency to intermediate frequency downconverter 306 (hereinafter referred to as the RF/IF downconverter 306), an IF to baseband downconverter 308, an analog to digital (A/D) converter 322, an auxiliary analog to digital (A/D) converter 320 and an Analog Received Signal Strength Indication (ARSSI) portion 310 (also referred to generically as a received signal strength module 310). Also shown is a baseband integrated circuit device 312 (also referred to as the baseband IC device 312) coupled to the RF/IF IC device 304 that comprises a demodulator 314, a preamble detector 315 (also referred to generically as a “co-channel signal detector”), a dynamic channel selection module 316 (also referred to as the DCS module 316), and an available channel select signal 318. It is noted that in some embodiments, the antenna 302 may be implemented within the RF/IF IC device 304.

Upon power-up of the AP, the receiver 300 needs to select a channel for use out of the available channels in an operating band. This process undertaken by the receiver 300 is called initial DCS (IDCS). The initial DCS algorithm at the receiver 300 is employed to avoid selecting occupied channels (or more precisely, any available channel with poor quality) and ensure a uniform spreading of the devices over all the available channels.

After the Initial DCS algorithm is carried out by the receiver 300, and an available channel is selected, the AP starts its normal operation using the selected channel for communications with other terminals. In several embodiments, however, the AP will monitor the quality of the selected channel and will initiate the DCS algorithm in the event the quality of the selected channel deteriorates. This process is called Ongoing DCS (ODCS). Ongoing DCS ensures using the best operating available channel with minimum level of interference, during the entire operation of the AP.

Upon power-up of the AP, the DCS module 316 starts by sending a command, e.g., the available channel select signal 318 to the tuner 305 to tune into a first of the available channels (e.g., a first of available frequency, time, or code channels). The antenna 302, coupled to the tuner 305, receives signals present on the first of the available channels and the signals are provided (through the tuner 305) to the RF/IF downconverter 306.

In several embodiments, received signal strength measurements of the signals, e.g., Analog Received Signal Strength Indication (ARSSI) measurements of the signals, are taken at an intermediate frequency to determine the interference levels in all available channels because baseband processing cannot be utilized before an available channel is selected and RF processing is generally too expensive to be practical. Thus, after the RF/IF downconverter 306 (the output of which is coupled to the received signal strength module 310) receives the signals and converts the signals to intermediate frequency signals, the intermediate frequency signals are provided to the received signal strength module 310. The received signal strength module 310 (also coupled to the auxiliary A/D converter 320) then takes Analog Received Signal Strength Indication (ARRSI) measurements (generically referred to as received signal strength measurements) of the intermediate frequency signals. These received signal strength measurements are provided to the auxiliary A/D converter 320 and are converted to digital representations of the received signal strength measurements (generally referred to a received signal strength measurements). The digital representations of the received signal strength measurements are indicative of the level of interference of the available channel and are provided from the auxiliary A/D converter 320 to the DCS module 316. The same process of tuning to an available channel and collecting measurements is repeated for all available channels. Thus, a plurality of received signal strength measurements are taken for each of the plurality of available channels (Step 402 of FIG. 4).

In one embodiment, the DCS module 316 will take every Kth one out of L total discrete received signal strength measurements taken at the received signal strength module 310. Denoting N (in milliseconds) as the size of the measurement window taken by the received signal strength module 310, and a total number of L discrete measurements taken at the received signal strength module 310 assuming that ARSSI measurements are updated every 1 μs, the number of received signal strength measurements input to the DCS module 316 is:

$$1000 * \frac{N}{K} . \qquad Eq . ( 1 )$$

For example, if K=4, then the DCS module 316 receives 250*N discrete received signal strength measurements from the received signal strength module 310. As another example, if K=1, the DCS module 316 receives all of the received signal strength measurements taken by the received signal strength module 310.

In other embodiments, instead of taking one discrete measurement out of every K discrete measurements, the received signal strength module 310 averages a small number (e.g., K) of the L discrete received signal strength measurements to provide a single average measurement which is input to the DCS module 316. For example, the number of discrete measurements that are averaged may be within a range from one to sixteen discrete measurements. For example, if every four discrete measurements are averaged during the measurement window of N milliseconds, 250 times N single average measurements may be calculated. In some embodiments, a measurement window of approximately 1 millisecond is utilized and 250 of these single average measurements (derived from 1000 discrete measurements) are retained as received signal strength measurements input to the DCS module 316. While the received signal strength module 310 in the present embodiment calculates single average measurements from the discrete received signals strength measurements, one of ordinary skill in the art recognizes that this functionality may be performed elsewhere, e.g., by the DCS module 316.

Thus, in some embodiments, the received signal strength measurements utilized by the DCS module 316 correspond to the L discrete measurements taken at the received signal strength module 310. For example, in one embodiment, the received signal strength measurements used by the DCS module 316 are all of the L discrete received signal strength measurements (i.e., K=1) taken, and in other embodiments, the received signal strength measurements utilized by the DCS module 316 are a subset of the total number of L discrete received signal strength measurements taken (i.e., K>1), and in yet other embodiments, each received signal strength measurement utilized by the DFS module is an average of a small number of the L discrete received signal strength measurements taken at the received signal strength module 310.

After the received signal strength measurements are established for the first available channel, a channel metric for the first available channel is derived (e.g., at the DCS module 316) from the received signal strength measurements taken over that first available channel. This channel metric is indicative of a level of interference present in the available channel. Similarly, channel metrics for other available channels are derived from their respective received signal strength measurements. Thus, a channel metric for each of the plurality of available channels based on the received signal strength measurements is determined (Step 404 of FIG. 4), the channel metrics indicative of the level of interference present in the available channels.

In one embodiment, when determining the channel metric for a given channel, the DCS module 316 retains the M largest measurements (e.g., 32 of the largest measurements) of the number of received signal strength measurements (taken from a given available channel) that are provided to the DCS module 316 from the received signal strength module 310. The DCS module 316 then computes a channel metric for that available channel by averaging these M largest measurements. It should be recognized that the M largest received signal strength measurements retained by the DCS module 316 may be the M largest of discrete received signal strength measurements received at the DCS module 316 or may be the M largest of averaged received signal strength measurements received at the DCS module 316.

The same process of tuning to an available channel, retaining the M largest measurements, and finally computing a channel metric will be repeated for all available channels. Thus, letting I denote the number of available channels and letting i denote a channel index, a channel metric mᵢ for available channel i is defined in the following manner:

$${m}_{i} = \frac{1}{M} {\sum }_{j = 1}^{M} Max\_ARRSI [ j ] i = 1 , 2 , … , I \qquad Eq . ( 2 )$$

Where M, as discussed, denotes the M largest ARSSI measurements out of the received signal strength measurements utilized the DCS module 316, j is an index of the M measurements and Max_ARSSI[j] is one of the M retained received signal strength measurements where Max_ARSSI{M} denotes a vector of size M containing these M largest retained received signal strength measurements.

It should be recognized that equation (2) above may be generally applied to systems having more than one available channel. Furthermore, the number M may vary depending on the system, number of channels, number of received signal strength measurements, etc.; however, the number M is generally small in comparison to the total number of received signal strength measurements. For example, in many embodiments, M may be up to 25% of the total number (e.g., L) of discrete received signal strength measurements taken during the measurement window. In some embodiments, M is up to 20% of the total number of discrete received signal strength measurements. Preferably, however, M is up to 15% of the number of discrete received signal strength measurements, and more preferably, M is up to 10% of the total discrete received signal strength measurements taken during the measurement window. It should be recognized, that M need not fall within these ranges in order to obtain a useful channel metric, but when M is within one of the ranges set forth above, the resulting channel metrics will provide a more accurate representation of the level of interference on the available channels. More particularly, M will provide a more accurate picture of an interference level that may indicate the presence of a minimum interfering co-channel signal on the available channel (e.g., a beacon transmitted by another terminal that may only occupy a small portion (e.g., 10%) of the measurement window).

In terms of equation (1), the M received signal strength measurements are retained out of L/K signal strength measurements that are received by the DCS module 316. Thus, defining M in an alternative way, the product of M and K (i.e. M times K) may be up to 25% of L, and in some embodiments, M times K is up to 20% of L. Preferably, however, M times K is up to 15% of L, and more preferably, M times K is up to 10% of L.

Accordingly, in one embodiment, for a measurement window of 1 msec, M is selected to be 32 out of the 1000 (L) measurements taken during the 1 msec window by the received signal strength module (assuming updates every 1 μs). Thus, M is 3.2% of L measurements, which fits within the above recited percentage ranges. Stated another way, if the DCS module receives every 4^{th} discrete measurement (K=4), then 250 discrete measurements are received at the DCS module and MK=128 which is 12.8% of the L discrete measurements taken during the measurement window. Again, this percentage also fits within the above recited ranges.

In other embodiments, different methods of computing a channel metric mᵢ that is indicative of the interference level on each of the available channels are utilized. For example, in one embodiment, many ARSSI measurements are taken over each available channel and each of the many measurements are set into one of a number of bins, where each bin represents a range of received signal levels. A histogram is then created indicating the percentage of the many measurements that fall within each bin. From the histogram, a median curve for each available channel indicative of the received signal strength over each available channel is established, and this curve is translated into a channel metric for each available channel. This histogram-based method is well known in the art, and is disadvantageous in many systems (e.g., synchronous media access control (MAC) systems) because the histogram is utilized to provide an overall average of the noise of the MAC frame and when ARSSI measurements are taken, typically only 10% of the MAC frame is utilized as a beacon. Thus, using the histogram-based method, 90% of the time the received signal strength measurements taken are noise floor measurements. As a result, measurements of a particular available channel's received signal strength are often inaccurate because 90% of the time only the noise floor is seen on the available channel.

Thus, as discussed above, it is preferable to calculate the channel metrics from the M largest received signal strength measurements because the M largest received signal strength measurements are more likely to produce more accurate measurements of co-channel signals (e.g., a beacon) rather than background noise. This is because background noise is more likely to be a smaller component of the average of the M largest measurements than an average of all or a larger number of received signal strength measurements. Thus, according to several embodiments, the quantity M is selected so that the M received signal strength measurements (either discrete or averaged) corresponding to the discrete measurements taken at the received signal strength module 310 will be measurements that fall within a minimum co-channel signal (e.g., a beacon) occupying a portion of the measurement window (e.g., about 10% of the measurement window). Thus, in many embodiments, the specific percentage ranges of M as described above are based upon the size of a beacon such that M is preferably less than or equal to the number of received signal strength measurements that may be taken during the duration of such a beacon.

After determining the channel metrics mᵢ for all the available channels, the DCS module 316 proceeds by sorting the plurality of available channels according to their respective channel metrics (Step 406 of FIG. 4). In one embodiment, the available channels are sorted by their respective channel metrics in ascending order.

In several embodiments, the set of unsorted available channels is represented mathematically by UM{I} which denotes a vector of unsorted channel metrics of size I defined as: UM{I}=[m₁ m₂ m₃ . . . m_{I}] where I is the number of available channels. After sorting, the set of sorted channels is represented by CM{I} which denotes a sorted channel metric vector of size I, where elements of the CM vector are the individual channel metrics mᵢ's in ascending order, i.e., CM{I}=sort(UM{I}), and CM[1]≦CM[2]≦ . . . CM[I]. Therefore, in this embodiment, CM[1] is the minimum channel metric of the available channels, and CM[I] is the maximum channel metric of the available channels. Also, a channel index vector, CI{I} of size I is defined where:

CM[i]=UM[CI[i]], i=1, 2, . . . , I Eq. (3)

Thus, CI[1] is the available channel having the minimum channel metric, and CI[I] is the available channel having the maximum channel metric.

In several embodiments, when there is more than one available channel having the same minimum channel metric, a randomization process is utilized to establish which of the available channels having the minimum channel metric is indexed as CI[1]. As discussed further herein, in several embodiments, when an available channel indexed by CI[1] has no co-channel signal present on it, that available channel CI[1] is chosen for communications. Thus, without such a randomization process, if channel 1 and channel 2 both have the minimum channel metric, it is possible that channel 1 will be always selected as a communications channel (assuming there is no co-channel signaling present in either of these two channels). To prevent a particular available channel, e.g., channel 1, from always being selected when other available channels have the same minimum channel metric, the indexed order of the available channels having the minimum channel metric are shuffled randomly. For example, when there are two available channels that have the minimum channel metric, e.g., channel 1 and channel 2, each available channel having the minimum channel metric is assigned a 50% probability of being assigned as CI[1]. In this way, channel 2 for example, has a 50% chance of being assigned the position of CI[1]. When more than two available channels have the same minimum channel metric, the randomization process is utilized to generate a random order of the available channel indexes. For example, if channels 1, 4, and 6, each have the minimum channel metric and are indexed as CI[1], CI[2], and CI[3] respectively before the randomization process, after the randomization process, their order in the sorted channel metric might change depending upon the outcome of the randomization process. For example, after the randomization process, channel 6 potentially may be indexed as CI[1] instead of its previous index of CI[3] and channels 1 and 4 may be indexed as CI[2] and CI[3] respectively. In this way, each of the three channels having the minimum channel metric has a 33.3% chance of being assigned the position of CI[1]. Thus, the incorporation of the randomization process in the sorting step of the DCS algorithm further enhances the uniform spreading of the devices on all available channels because the potential exists for multiple channels having the minimum channel metric to be utilized for communications.

After the available channels are sorted, in some embodiments, the DCS module 316 determines whether the channel metric of the available channel having the lowest channel metric of the available channels, i.e., CM[1], is greater than an upper threshold (UT) (Step 408 of FIG. 4). In several embodiments, Step 408 of FIG. 4 is not performed or the upper threshold is ignored and the DCS module 316 continues to analyze the available channel having the lowest channel metric of the available channels without comparing it against a threshold. This approach is often viable, at least when access points, e.g., AP1 and AP2, are configured to provide a rate and power control (RPC) algorithm to adjust their respective rates and powers in response to interference present in communication channels. When AP1 and AP2 are configured to provide both RPC and DCS algorithms, ignoring the upper threshold is often a viable approach because RPC and DCS algorithms may be tightly tied together, and it can be expected that after an access point e.g., AP1, selects an available channel which is used by another AP, e.g., AP2, in the near vicinity, the RPC algorithm will engage and then both AP's, e.g., AP1 and AP2, will try to adjust their rates and powers to maximize the throughput and minimize the interference in the system. Therefore, in some embodiments, it is reasonable to continue with the DCS algorithm even if a threshold is exceeded.

In other embodiments, however, it is desirable to have at least one available channel having a channel metric below an upper threshold. One possible solution is to continue searching for an available channel having a channel metric below the upper threshold by once again taking a plurality of received signal strength measurements for each of the available channels (Step 402 of FIG. 4), i.e., starting the process of selecting an available channel over again until an available channel having a channel metric that meets the threshold is detected. In such a case, a user interface may display a message such as “Searching . . . ”, to indicate to the user that an available channel is yet to be selected. This, however, could be very frustrating for the user and may result in long delays before selecting an available channel for communications.

In yet other embodiments, features of both the above suggested solutions for the problem of having the minimum channel metric being above a prescribed threshold are utilized. In such embodiments, a retry counter r is defined and set to zero when the DCS algorithm initiates. After all channel metrics have been determined, if the minimum channel metric, i.e., CM[1], is above an upper threshold and the retry counter is less than a prescribed maximum number of retries R, the DCS process is restarted again, i.e., the available channels will be probed again (Step 402 of FIG. 4). This process will be repeated up to R times when the minimum channel metric exceeds the upper threshold, and if after R tries the minimum channel metric is still above the upper threshold, the available channel with the minimum channel metric will be selected. In systems incorporating a rate and power control (RPC) algorithm, there is an increased possibility that the RPC process will result in acceptable interference levels in the system.

Next, whether or not Step 408 of FIG. 4 is performed, a determination is made as to whether co-channel signaling is present on the available channel having the lowest channel metric (i.e. CI[1]) of the available channels. (Steps 410 of FIG. 4). As used herein, “co-channel signaling” refers to other interfering communications received on the available channel CI[1] that are highly correlated with signals used by the present system, but are not generated by either the receiver 300 of the present system or the terminals it is intended to communicate with. These co-channel signals may be any other communication burst from another transmitter in the vicinity. The co-channel signaling represents a co-channel interference that typically cannot be removed in the baseband processing as opposed to adjacent channel interference. Generally, co-channel signaling may be found by correlating the received signal with a signature of a known signal. As discussed, a signal (e.g., a signal from outside the present system) sharing the same channel with a desired signal of interest in the present system is considered a co-channel signal if it is highly correlated with the desired signal. If two signals sharing the same channel are uncorrelated then they are not considered co-channel signals in this context. Such an uncorrelated signal sharing the same channel with the signal of interest increases the system noise floor (i.e. reduces the effective signal to noise ratio in the channel). As long as the increase in the noise floor is within a specified threshold (as defined by industry standard), the system is likely to operate properly.

In one embodiment, the determination as to whether co-channel signaling is present on CI[1] is made by the preamble detector 315. In this embodiment, the RF/IF downconverter 306 couples to the IF to baseband downconverter 308 and provides the intermediate frequency signals to the IF to baseband downconverter 308. The IF to baseband downconverter 308 then converts the intermediate frequency signals to baseband signals and provides the baseband signals via coupling to the A/D converter 322. The A/D converter 322 digitizes the baseband signals and provides the digitized baseband signals to the preamble detector 315. If a preamble is detected in the digitized baseband signals by the preamble detector 315, the preamble detector 315 (coupled to the DCS module 316) provides a signal to the DCS module 316 indicating that a preamble is detected (i.e., the DCS module obtains an indication whether co-channel signaling is present on an available channel having a lowest channel metric of the plurality of available channels.) If no preamble is detected the lowest channel metric is chosen for communications.

If there is no co-channel signaling present on the available channel having the lowest channel metric (Step 412 of FIG. 4), then the available channel having the lowest channel metric is selected for communications (Step 414 of FIG. 4). This selection is made because when there is no co-channel signaling on the available channel having the lowest channel metric (i.e., available channel CI[1]) no other available channel will have a level of interference that can be reduced below the level of interference present on CI[1].

Thus, the DCS algorithm advantageously distinguishes between co-channel interference and adjacent channel interference which allows the receiver 300 to make a more “intelligent” decision about whether to use CI[1] for communication than prior art methods. This is because the DCS module 316 is able to determine if the interference on CI[1] is solely adjacent channel interference, and if so, then to select CI[1]. Under prior art systems, only the magnitude of interference on CI[1] is utilized, and a prior art receiver may pick an available channel CI[1] having co-channel interference (CCI) that cannot be filtered to a level that is below another available channel having only adjacent channel interference (ACI), or a combination of CCI and ACI.

In other embodiments, the determination as to whether co-channel signaling is present on CI[1] may be made by identifying a particular known signature of the co-channel signaling. Thus, in other embodiments, the preamble detector 315 may be replaced with a signature detector module to identify the anticipated signature of the co-channel signaling.

If co-channel signaling is detected on the available channel having the lowest channel metric (Step 412 of FIG. 4)(e.g., a PHY preamble is detected on CI[1]), then a comparison of the channel metric of the available channel having the lowest channel metric with a channel metric of an available channel having a higher channel metric is made (Step 416 of FIG. 4). This comparison is made because, as discussed above, baseband filtering can remove adjacent channel interference, but cannot effectively remove co-channel interference. Thus, when there is co-channel interference on the available channel having the lowest channel metric, there may be an available channel having only adjacent channel interference that can be filtered down to an interference level that is lower than that of the available channel having a lower channel metric (with co-channel signaling present).

In several embodiments, if co-channel signaling (e.g., a PHY preamble) is detected on the available channel CI[1] (Step 412 of FIG. 4), then CI[1] is compared with other available channels starting from available channel CI[2] to determine if the difference between the channel metric of all the other available channels have channel metrics that are greater than the channel metric of CI[1] by more than a prescribed threshold above CM[1]. The prescribed threshold depends upon the effectiveness of baseband processing to filter adjacent channel interference from available channels having a higher channel metric than CI[1]. In several embodiments, the prescribed threshold is about 10-15 dB so that available channels having a channel metric greater than the channel metric of CI[1] by more than about 10-15 dB have a channel metric that is greater than CI[1] by more than the prescribed threshold.

If all the other available channels have channel metrics that are greater than the channel metric of CI[1] by more than the prescribed threshold (Step 418 of FIG. 4), then CI[1] is selected as an available channel for communications (Step 420 of FIG. 4). The reason for such a selection is that, (at this stage) it is known that available channel CI[1] has co-channel signaling (as opposed to having only adjacent channel signaling) present that cannot be filtered out, but only a prescribed amount of adjacent channel interference (ACI) will be removed by the digital baseband filtering from available channels having a higher channel metric than CI[1]. Therefore, even if the signal activity on available channels other than CI[1] is only adjacent channel interference, if the channel metric of CI[1] is lower than all of these available channels by more than the prescribed threshold, digital baseband filtering cannot generally reduce the ACI in any of these available channels to a level below that of CI[1]; thus, CI[1] is the best candidate.

If however, there are other available channels that do not have co-channel signaling on them and the signal activity on these other available channels is not greater than the signal activity on CI[1] by more than the prescribed threshold, then CI[1] is no longer the best candidate. This is because baseband filtering can filter out the adjacent channel interference up to about the prescribed threshold (which in several embodiments is about 10-15 dB). It is beneficial, therefore, to determine whether any of the available channels having a higher channel metric than CI[1] have co-channel signaling present on them. Thus, in several embodiments, when there is an available channel having a channel metric that is higher than CM[I] by less than the prescribed threshold (Step 418 of FIG. 4), the DCS algorithm determines whether co-channel signaling is present on the available channel having a higher channel metric (Step 422 of FIG. 4) than CI[1]. The determination as to whether co-channel signaling is present on the available channel having a higher channel metric may be made in a similar manner as the determination as to whether co-channel signaling is present on CI[1] described above. Thus, the DCS algorithm provides advantages over the prior art (which only considered the magnitude of interference) because both the magnitude and the type of interference present on an available channel are factors used by the DCS algorithm that allow the receiver 300 to select an available channel that may be filtered to a lowest level of interference among the available channels.

In one embodiment, the determination of whether co-channel signaling is present on an available channel having a higher channel metric than CI[1] involves the DCS algorithm determining, beginning with an available channel CI[2] and proceeding in order to the other available channels, whether co-channel signaling is present on each of the available channels having a channel metric greater than CM[1]. Once a particular available channel is found that does not have co-channel signaling present on it (and the particular available channel has signal activity that is no stronger than the signal activity of CI[1] by no more than the prescribed threshold) that particular available channel is selected for communications. As described above, co-channel signaling is signaling that is highly correlated with the signaling of the present system. In several embodiments, the determination as to whether co-channel signaling is present on other available channels having a higher channel metric than CI[1] comprises a determination as to whether a PHY preamble is present on the available channels having higher channel metrics. In one embodiment, the preamble detector 315 detects whether a preamble is present on the available channels having higher channel metrics than CI[1] in the same way the preamble detector 315 detects whether a preamble is present on CI[1] in the embodiment discussed above; thus, the DCS module 316 obtains an indication (e.g., a signal from the preamble detector 315) whether the preamble is present on the available channels having higher channel metrics.

If all available channels other than CI[1] have co-channel signaling on them, then the DCS algorithm selects the available channel with minimum interference, i.e., available channel CI[1], regardless of any co-channel signaling present on CI[1]. Thus, the DCS algorithm selects a channel for communications based upon whether the co-channel signaling is detected on the available channel having the higher channel metric (Step 424 of FIG. 4)(i.e., a higher channel metric than CI[1]).

Thus, according to one embodiment, the DCS algorithm selects an available channel for communications based upon one or more of the following criteria: (a) whether co-channel signaling is present on the available channel having the lowest channel metric; (b) the difference between the available channel having the lowest channel metric and the available channel having a higher channel metric; and (c) whether co-channel signaling is detected on the available channel having a higher channel metric.

In several embodiments, the DCS algorithm is applied both to provide an Initial DCS (IDCS) at the time during which the AP is powered-up, and to provide Ongoing DCS (ODCS) during the AP operation. When the ODCS algorithm is engaged, all terminals in the given cell stop communicating so that received signal strength measurements may again be taken, and the same process for selecting one of the available channels is carried out as discussed above. The reasons for the ODCS process to engage may be high error rates, a large number of cyclic redundancy check (CRC) errors, or retransmissions. One or a collection of these parameters may be used at the AP to decide whether the AP should enter the DCS mode again to find a better available channel to avoid further deterioration of the system throughput in the immediate future.

In some embodiments, the DCS operation will be entirely handled by the AP, and no assistance will be provided by the RTs for the ODCS process. In other embodiments, however, provisions in the media access control (MAC) design may be made to facilitate the participation of RTs in the ODCS process to assist the AP in finding the best available channel to move to. In such an embodiment, the AP delegates to the RT the process of making measurements on other available channels. The RT then sends a report back to the AP at the end of the measurement process. During this time, the AP will not schedule any traffic to this delegated RT. This kind of DCS process is denoted as RT Assisted DCS (RADCS). Thus, it should be recognized that the steps of the DCS algorithm need not be carried out solely by elements of the AP and may be performed by other components of the communication system.

Referring next to FIG. 3B, shown is a functional block diagram of several components of another embodiment of the receiver of FIG. 3A, which according to several other embodiments of the invention, implements the dynamic channel selection algorithm for selecting one of many available channels for communications with other communication terminals.

Shown is the receiver 350 including the antenna 302, a radio frequency/baseband frequency integrated circuit device 326 (hereinafter referred to as the RF/BB IC device 326) that comprises the tuner 305, a radio frequency to baseband frequency downconverter 324 (hereinafter referred to as the RF/BB downconverter 324), the analog to digital (A/D) converter 322, the auxiliary analog to digital (A/D) converter 320 and the Analog Received Signal Strength Indication (ARSSI) portion 310 (also referred to generically as the received signal strength module 310). Also shown is the baseband integrated circuit device 312 (also referred to as the baseband IC device 312) coupled to the RF/BB IC device 326 that comprises the demodulator 314, the preamble detector 315 (also referred to generically as the “co-channel signal detector”), the dynamic channel selection module 316 (also referred to as the DCS module 316), and the available channel select signal 318. It is noted that in some embodiments, the antenna 302 may be implemented within the RF/BB IC device 326.

The receiver 350, in several embodiments, operates in much the same way as the receiver 300 of FIG. 3A; however, the signals from the tuner 305 are received by the RF/BB downconverter 324 and converted directly to baseband frequency instead of being converted to an intermediate frequency. Thus, in the present embodiment, the RF/BB downconverter 324 provides the signals at baseband frequency to the received signal strength module 310 where received signal strength measurements are taken of the signals at baseband frequency instead of at an intermediate frequency. Thus, the receiver 350 may be referred to as a zero IF receiver.

Another difference between the receiver 300 and the receiver 350 is that the baseband signals from the RF/BB downconverter 324 are provided directly to the A/D converter 322. Thus, in the present embodiment, baseband signals from the RF/BB downconverter 324 are provided to the A/D converter 322 where the baseband signals are digitized. The digitized baseband signals from the A/D converter 322 are then provided to the preamble detector 315 where the determination as to whether co-channel signaling is present on a particular channel is made in accordance with the steps set forth in FIG. 4.

It is noted that many of the functional blocks of the receivers 300, 350 of FIGS. 3A and 3B may be implemented as a set of instructions that are performed in dedicated hardware, firmware or in software using a processor or other machine to execute the instructions to accomplish the provided functionality. For example, in one embodiment, the receivers 300, 350 of FIGS. 3A and 3B may be implemented as one or more integrated circuit (IC) devices.

For example, in one embodiment, the antenna 302, the tuner 305, the RF/IF downconverter 306, the IF to baseband downconverter 308, the auxiliary A/D converter 320, the A/D converter 322, and the received signal strength module 310 are implemented on the RF/IF IC device 304, while the remaining functional components of the receiver, including the DCS module 316 are implemented on the baseband IC device 312, which is coupled to the RF/IF IC device 304.

In another embodiment, implemented according to a zero IF architecture, e.g., the embodiment of FIG. 3B, the antenna 302, the tuner 305, the RF/BB downconverter 324, the auxiliary A/D converter 320, the A/D converter 322, and the received signal strength module 310 are implemented on the RF/BB IC device 326, while the remaining functional components of the receiver 350, including the DCS module 316 are implemented on the baseband IC device 312, which is coupled to the RF/BB IC device 326.

These integrated circuit devices 304, 326 and 312 may be referred to application specific integrated circuits (ASICs) or generically as chips. Alternatively, the RF/IF IC device 304, the RF/BB IC device 326 and the baseband IC device 312 may be implemented as a single chip or ASIC. Thus, the RF/IF IC device 304, the RF/BB IC device 326 and the baseband IC device 312 may be a part of a chipset or a single chip or ASIC designed to implement the function blocks of the receivers 300, 350. Similarly, the steps of FIG. 4 may be performed as a set of instructions that are performed in dedicated hardware, firmware or in software using a processor or other machine to execute the instructions to accomplish the given steps.

Referring next to FIG. 5, shown is a flowchart illustrating the steps performed by the access point of FIG. 3A or FIG. 3B in implementing the DCS algorithm for selecting between available frequency channels in accordance with one embodiment of the present invention.

In the present embodiment, eight nominal carrier frequencies are available in a frequency band from 5150 MHz to 5350 MHz; thus, in the present embodiment, the available channels are eight available frequency channels (i.e., I=8). The nominal carrier frequency f_{c} corresponds to its carrier number, N_{carrier}, which is defined as:

N_{carrier}=(f_{c}−5000 MHz)/5 MHz Eq.(4)

The nominal carrier frequencies are spaced 20 MHz apart, and all transmissions are centered on one of the nominal carrier frequencies.

In the present embodiment, the DCS algorithm is employed to avoid occupied frequency channels at a time of power-up and to ensure a uniform spreading of 5 GHz devices over all the available channels. As discussed, Ongoing DCS ensures that the best operating frequency channel is used with the minimum level of interference during the entire operation of the AP. Thus, DCS operation initially avoids occupied frequency channels that have a high level of interference at the time of power-up, and Ongoing DCS minimizes the interference in the system by moving to the appropriate available channel during operation of the system. Such operation will support high density deployments for the 5 GHz wireless devices.

Upon power-up, the DCS algorithm is started (Step 502), and the channel index i is set to 1 (Step 504). If the channel index i is not greater thaneight (Step 505), an available channel is selected by tuning (e.g., with the tuner 305 of FIG. 3) to that available channel (Step 506) and a DCS measurement window of size N milliseconds is opened (Step 508). In several embodiments, received signal strength measurements are collected over the available channel i during a measurement window of about 2 milliseconds. These measurements are taken by the received signal strength module 310 of FIG. 3, for example. In one embodiment, discrete received signal strength measurements are utilized, and using equation (1), the number of received signal strength measurements used to assist the DCS algorithm, assuming one out of every K measurements are input to the DCS module 316, a 2 millisecond measurement window is utilized and assuming received signal strength measurements are updated every 1 μs is: 2000/K. Alternatively, in another embodiment, every four discrete received signal strength measurements are averaged to provide 500 received signal strength measurements that are each an average of four discrete received signal strength measurements. It should be recognized, however, that the time period allocated for the measurement window (Step 508) may vary depending upon the size of the MAC frame, but preferably the measurement window N is at least the size of the MAC frame.

Of the received signal strength measurements, the M largest of the received signal strength measurements are retained (Step 510), e.g., in one embodiment M=32. Next, a channel metric for this first available channel is determined by averaging these M largest measurements using equation (2) (Step 512). The same process of tuning to an available channel, collecting measurements, and finally determining the channel metric will be repeated for all I available channels, e.g, all eight available channels. Thus, after the channel metric is computed for the first available channel (i.e., i=1), the channel index i is incremented by one (Step 514), and Steps 506 through 514 are repeated until i>I (e.g., until i>8) (Step 505), at which point a channel metric will have been determined for each of the available channels. It is noted that other methods may be used to determine the channel metric mᵢ for each available channel, as described herein. Thus, Steps 504 through 514 represent one embodiment of accomplishing steps 402 and 404 of FIG. 4.

After gathering the channel metrics for all the eight available channels, the DCS algorithm proceeds by sorting the available channels by their respective channel metrics in ascending order (Step 516).

Next, the DCS algorithm compares the CM[1] element, which is the available channel with the minimum channel metric (also referred to as the QUIETEST channel, among all the eight available channels) against an upper threshold (UT) (Step 520). If the signal activity in the QUIETEST channel is above the upper threshold, this means that none of the available channels are “interference free enough” to be selected, and in one embodiment, a retry counter (that is set to zero upon initiation of the DCS algorithm) is incremented by one (Step 518). If the retry counter is less than a predetermined maximum number of attempts R (Step 519), the DCS process is restarted again (Step 502), i.e., the available channels will be probed again. This process of tuning into each of the eight available channels, taking measurements, and calculating a channel metric for each of the eight available channels will be repeated up to R times, and if the lowest channel metric of the eight available channels still exceeds the upper threshold (Steps 520 and 519), the available channel with the minimum channel metric, i.e. CI[1] is selected for communications (Step 524).

If CM[1] is not greater than the upper threshold (UT) (Step 520), then a determination is made as to whether a PHY preamble can be detected on available channel CI[1] (Step 522), i.e., it is determined if co-channel signaling is present on CI[1]. If a preamble is not detected (Step 522), it means that, probably this is not a co-channel signal (but there might be a non 802.11a device in the same band), and available channel CI[1] is selected (Step 524).

If a PHY preamble is detected on available channel CI[1] (Step 522), then the DCS algorithm starts searching for an available channel having a higher channel metric with an acceptable level of interference that does not have a preamble (i.e., one example of a co-channel signal) on it (Step 526). The first step in the search for such an available channel is to compare available channel CI[1] with the other available channels starting from available channel CI[2] by subtracting the channel metric of CI[1], i.e., CM[1], from the channel metrics of the available channels with higher channel metrics starting with CI[2] (Step 528).

The next test is to check whether signal activity in available channel CI[2] is stronger than signal activity in available channel CI[1] by more than a threshold of approximately 10 dB (Step 530). The reason for this comparison is that, at this stage, it is known that CI[1] is a co-channel signal with signal activity less than available channel CI[2]. If the signal activity in available channel CI[2] is because of an adjacent channel signal, digital baseband filtering can reduce only up to about 10 dB of ACI. Therefore, if the signal activity in available channel CI[2] is more than 10 dB stronger than that of the first available channel CI[1], then CI[1] will be the best candidate. Thus, when CM[2]-CM[1]>10 dB (Step 530) available channel CI[1] is selected (Step 524) even though the source of interference on CI[1] is a co-channel signal because, even if the source of interference in CI[2] was due to adjacent channel signal, the baseband filtering cannot further reduce it below CM[1].

If CM[2] is not greater than CM[1] by more than about 10 dB (Step 530), then a determination is made as to whether a preamble exists on CI[2] (Step 532 and 534). If a preamble is not detected in available channel CI[2], then CI[2] is selected (Steps 536) because (at this stage) it is known that the interference on CI[2] is from ACI and that baseband filtering can reduce the ACI interference on CI[2] below the interference level on CI[1]. Otherwise, if a preamble is detected on available channel CI[2] (Step 534), the search continues by incrementing the channel index (Step 538) to find an available channel without co-channel signaling that has signal activity that is not greater than about 10dB more than that of CI[1]. This continuing search involves repeating Steps 528 through 540 as necessary while the channel index i less than eight (Step 540). If all available channels are exhausted and still no available channel is selected (i.e., the channel index i is greater than or equal to eight (Step 540)), the DCS algorithm selects the available channel with the minimum level of interference, available channel CI[1] (Step 524).

Once an available channel is selected, the DCS algorithm continues to monitor the communications taking place for a DCS triggering event as part of an Ongoing DCS (ODCS) operation (Step 542). Potential DCS triggering events include high error rates, a large number of CRC errors, or retransmissions. One or a collection of these parameters may be used at the AP to trigger the start of the DCS algorithm again (Step 502) to find a better available channel to avoid further deterioration of the system throughput in the immediate future.

The steps of the DCS algorithm shown with reference to FIG. 5 in several embodiments are handled by the AP, without assistance from the RTs. In other embodiments, however, provisions may be made in MAC design to facilitate the participation of RTs in the ODCS process to assist the AP in finding the best available channel to move to. In such a case, the AP will give delegation to the RT to go and make measurements on other available channels and send a report back to the AP at the end of the measurement process. During this time, the AP will not schedule any traffic to this delegated RT. Such a process may be referred to as RT Assisted DCS (RADCS).

It is noted that the steps listed in FIG. 5 generally represent the steps in performing the DCS algorithm according to several embodiments of the invention. These steps may be performed by the DCS module 316 of FIG. 3A or FIG. 3B and/or may be performed as a set of instructions that are performed in dedicated hardware, firmware or in software using a processor or other machine to execute the instructions to accomplish the given steps.

It is also noted that the steps listed in FIG. 5 are adaptable to apply to selection of channel types other than frequency channels. One of ordinary skill in the art is readily able to adapt the steps of FIG. 5 so as to apply to systems in which a selection of, for example, either time channels or code channels is desired. For example, in one embodiment, Steps 504, 505, 506 and 508 are varied depending on the type of channel being chosen.

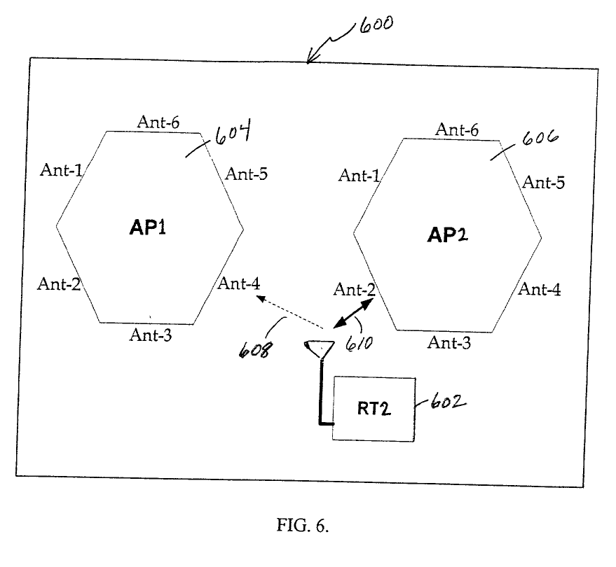

Referring next to FIG. 6, a diagram is shown illustrating interference between adjacent communication cells in which access points in each communication cell have multiple receive antennas. Shown are access points AP1 and AP2 that each have six receive antennas arranged with a hexagonal geometry (labeled respectively as Ant-1, Ant-2, Ant-3, Ant-4, Ant-5, and Ant-6). As shown, AP1 and AP2 are in close enough proximity to one another such that a signaling 610 transmitted between RT2 and AP2 is received at AP1 as interference 608.

AP1 and AP2 of FIG. 6 may operate, for example, in similar environments and in similar systems to AP1 and AP2 described with reference to FIG. 1. Thus, AP1 and AP2 of FIG. 6 potentially use the same channel or adjacent frequency channels for uplink and downlink transmissions in a wireless indoor network or a terrestrial cellular network. AP1 and AP2 of FIG. 6, however, have multiple receive antennas allowing each access point AP1, AP2 to receive a signal with more than one antenna.

Assuming AP2 is already up and running (i.e., it has selected an available channel for its operation and signaling 610 is being transmitted between RT2 and AP2), when AP1 powers up, it needs to select a different available channel for communications than the available channel selected by AP2.

In general, when an access point has multiple receive antennas, a received signal's strength on different antennas will not be the same, and the signal strength heavily depends on the geometry of the antenna array at the receiver and multi-path conditions. In the present embodiment, the received signal strength (RSS) of interference 608 received at Ant-1 of AP1 will be less than the RSS of interference 608 at Ant-4 of AP1. As discussed with reference to FIGS. 3, 4, and 5, received signal strength measurements are utilized for establishing channel metrics and ranking the available channels so that a given AP can decide which is the best available channel to utilize. Therefore, if a default antenna such as Ant-1 of AP1 is selected, and the DCS algorithm is utilized to sort the available channels and rank them only based on this one antenna, AP1 may end up choosing an available channel for communications that is not optimal. Thus, in several embodiments, the DCS algorithm accounts for each available receive antenna before ranking the available channels.

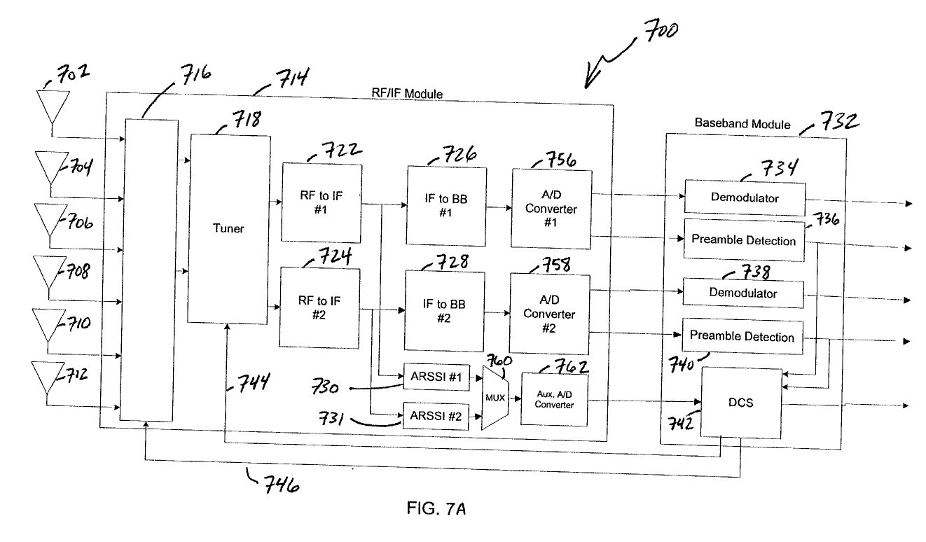

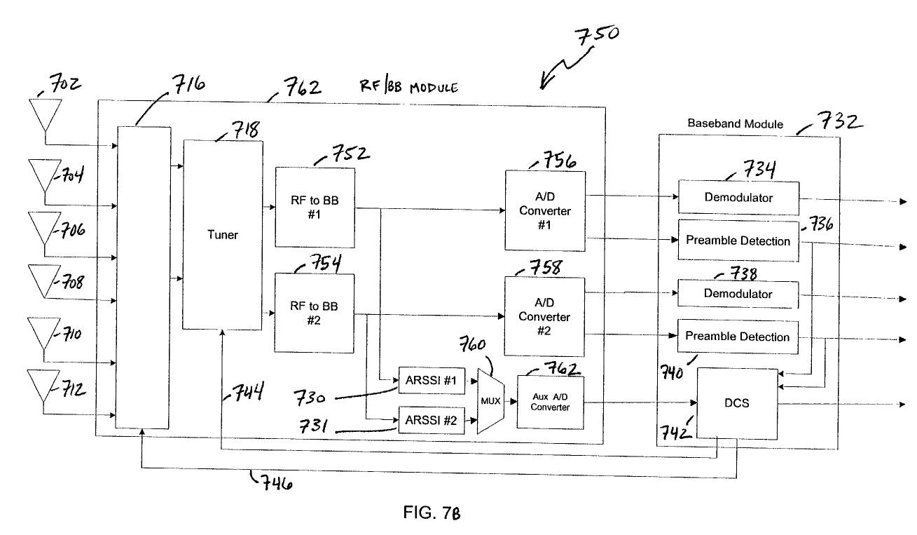

Referring next to FIG. 7A, shown is a functional block diagram of several components of a multi-antenna receiver 700 of a communication terminal, e.g., an access point of FIG. 6, which according to several embodiments of the invention, implements a dynamic channel selection algorithm for selecting one of many available channels for communications with other communication terminals

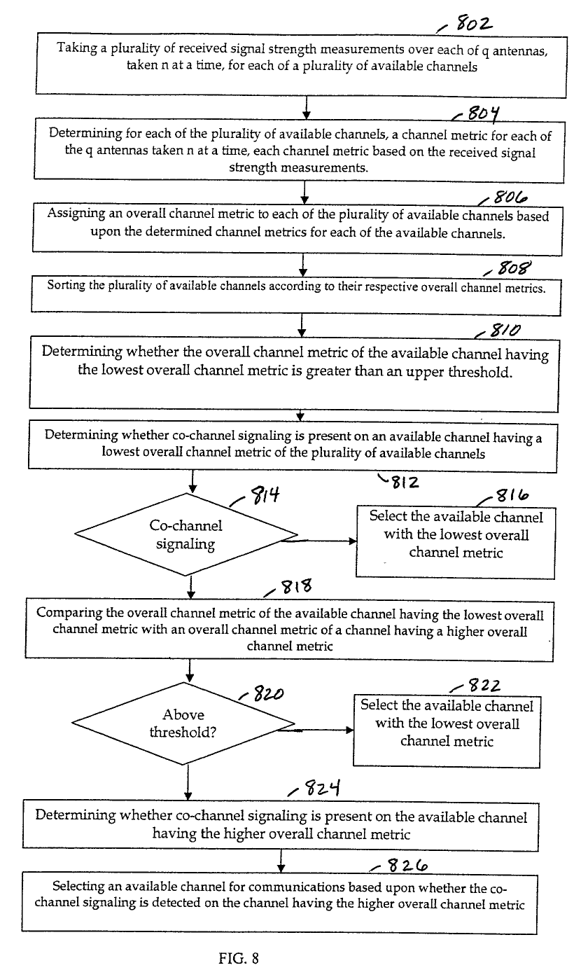

While referring to FIG. 7A, concurrent reference will be made to FIG. 8, which is a flowchart illustrating one embodiment of the steps of the dynamic channel selection algorithm which may be performed by the receiver of FIG. 7A or FIG. 7B for communications between various remote terminals and the access point.

Shown is a receiver 700 including antennas 702, 704, 706, 708, 710, 712, a radio frequency to intermediate frequency integrated circuit device 714 (hereinafter referred to as the RF/IF IC device 714) that comprises an antenna selector 716; tuner 718; radio frequency to intermediate frequency downconverters 722, 724 (hereinafter referred to as RF/IF downconverters 722, 724); analog to digital (A/D) converters 756, 758; IF to baseband downconverter portions 726, 728; a multiplexer 760; an auxiliary analog to digital (A/D) converter 762; and Analog Received Signal Strength Indication (ARSSI) portions 730, 731 (also referred to as a received signal strength modules 730, 731). Also shown is a baseband integrated circuit device 732 (also referred to as the baseband IC device 732) that comprises demodulators 734, 738; preamble detectors 736, 740 (also referred to generically as “co-channel signal detectors”); and a dynamic frequency selection module 742 (also referred to as the DCS module 742). Additionally shown is a channel select signal 744 that couples the DCS module 742 and the tuner 718 and an antenna select signal 746 that couples the DCS module 742 and the antenna selector 716.

The receiver 700 of FIG. 7A supports Q receive antennas (e.g., antennas 702, 704, 706, 708, 710, 712) and n receiver chains (e.g., two receiver chains), each receiver chain including a respective RF/IF downconverter, a respective IF to baseband downconverter and a respective demodulator. For example, receiver chain #1 includes RF/IF downconverter 722, IF to baseband downconverter portion 726, A/D converter 756, and demodulator 734 while receiver chain #2 includes RF/IF downconverter 724, IF to baseband downconverter portion 728, A/D converter 758 and demodulator 738. Thus, in the system illustrated, the receiver 700 receives signaling in two separate receive chains using two of the available receive antennas at any given time. This architecture facilitates diversity combining at the receiver 700 in a communication mode which results in considerable diversity gain for decoding the received signal. Additional details regarding the operation and features of receiver 700 may be found in patent application Ser. No. 09,944,519 entitled METHOD FOR ESTIMATING CARRIER-TO-NOISE-PLUS-INTERFERENCE RATIO (CNIR) FOR OFDM WAVEFORMS AND THE USE THEREOF FOR DIVERSITY ANTENNA BRANCH SELECTION to Crawford et al., filed Nov. 26, 2001, Attorney Docket No. 70629, incorporated herein by reference.

In this embodiment, to alleviate the problem of having different received signal strengths at different antennas for a particular access point, more than one antenna is evaluated to determine an overall channel metric for each available channel (e.g., for each available frequency, time, and/or code channel) based on the measured received signal strength at each of the antenna elements evaluated. For example, in one embodiment, all available antenna elements are evaluated to determine an overall channel metric for each available channel.

In several embodiments, a quantity of Q antennas may be sampled n antennas at a time (e.g., Q=6 and n=2 as illustrated in FIG. 7). Thus, the access point 700 takes a plurality of received signal strength measurements over each of Q antennas, taken n at a time, for each of a plurality of available channels (Step 802 of FIG. 8).

According to one embodiment, the process of taking the plurality of received signal strength measurements is initiated by the DCS module 742 which instructs the tuner 718 via an available channel select signal 744 to tune into a first of the available channels. Additionally, the DCS module 742 selects two particular antennas of the Q antennas (e.g., antennas 702, 704) by sending the antenna select signal 746 to the antenna selector 716 . In this embodiment, based upon the antenna select signal 746 from the DCS module 742, the antenna selector 716 selects the two particular antennas to receive signaling over the first of the available channels.

In one embodiment, the received signaling samples from two particular antennas (i.e., two samples of the received signaling) are carried from the two particular antennas through the antenna selector 716 and through the tuner 718 to the RF/IF downconverters 722, 724. The RF/IF downconverters 722, 724 each receive the signaling from a different path so that each of the RF/IF downconverters 722, 724 receives signaling from a different antenna. For example, the RF/IF downconverter 722 receives the signaling received at antenna 702 and RF/IF downconverter 724 receives the signaling received at antenna 704. The RF/IF downconverters 722, 724 (coupled to respective received signal strength modules 730, 731) then convert the two samples of the received signaling to two intermediate frequency signaling samples, and the intermediate frequency signaling is provided to the received signal strength modules 730, 731 where received signal strength measurements are taken for each of the two samples of the received signaling from the two particular antennas (e.g., antennas 702, 704). The multiplexer 760 connects one of the received signal strength modules 730, 731 at a time to the auxiliary A/D converter 762 where the received intermediate frequency signaling samples are digitized and provided to the DCS module 742.

FIG. 7A illustrates one embodiment having an antenna selector 716 that selects two of the six available antennas 702, 704, 706, 708, 710, 712 to allow received signal strength measurements to be taken by the received signal strength modules 730, 731 for two antennas at the same time. It should be recognized, however, that the DCS algorithm will accommodate receivers having a differing number of antennas Q, and will also accommodate receivers having only one receive chain or two or more receive chains so that one or more antennas may be accessed at the same time (i.e., generically, n may be greater than or equal to one).

After received signal strength measurements are taken, for each of the plurality of available channels, a channel metric (also referred to as an antenna channel metric) is determined for each of the Q antennas taken n at a time that is based upon the received signal strength measurements (Step 804 of FIG. 8) from the particular antennas. As discussed with reference to FIGS. 3A and 4, the channel metric established by the DCS module 742 may be based upon received signal strength measurements that are either discrete received signal strength measurements or an average of a small number (e.g., four) of discrete received signal strength measurements. Thus, the method discussed with reference to FIGS. 3A, 3B and 4 to calculate a channel metric for each available channel is applied to each antenna element separately so that for each of the available channels, a separate channel metric is determined for each antenna element that is based upon the received signal strength measurements for that given channel and antenna. These channel metrics are indicative of a level of interference seen over each available channel for each of the Q antennas.

In several embodiments, for each of the antennas selected for received signal strength measurements, the DCS module 742 retains the M largest received signal strength measurements and computes the channel metric for each antenna by averaging these M largest measurements. As discussed with reference to FIGS. 3A, 3B and 4, M may be up to 25% of the total number (e.g., L) of discrete received signal strength measurements taken during the measurement window. In some embodiments, M is up to 20% of the total number of discrete received signal strength measurements. Preferably, however, M is up to 15% of the number of discrete received signal strength measurements, and more preferably, M is up to 10% of the total discrete received signal strength measurements taken during the measurement window.

In terms of equation (1), the M received signal strength measurements are retained out of L/K signal strength measurements that are received by the DCS module 316. Thus, defining M in an alternative way, the product of M and K (i.e. M times K) may be up to 25% of L, and in some embodiments, M times K is up to 20% of L. Preferably, however, M times K is up to 15% of L, and more preferably, M times K is up to 10% of L.

In such embodiments, a two-dimensional channel metric m_{i,q} is defined as follows:

$${m}_{i , q} = \frac{1}{M} {\sum }_{j = 1}^{M} Max\_ARRSI [ j , q ] i = 1 , 2 , … , I , q = 1 , 2 , … , Q \qquad Eq . ( 5 )$$

where i is the available channel index, I is the total number of available channels, q is the antenna index, Q is the total number of antennas, M is an integer number representing the largest received signal strength measurements, and j is the index of the M largest measurements. However, it is noted that the channel metrics m_{i,q} may be determined using any known technique, e.g., using the histogram-based approach described above.

After a channel metric m_{i,q} is established for each of the antennas for each of the available channels, an overall channel metric \overline{mᵢ} is assigned by the DCS module 742 to each of the plurality of available channels based upon the determined channel metrics m_{i,q} for each of the plurality of available channels (Step 806 of FIG. 8).

In several embodiments, the overall channel metric for each of the available channels is assigned as the maximum antenna channel metric for each of the available channels. Thus, in several embodiments, the overall channel metric \overline{mᵢ} for an available channel i is defined as follows:

$$\overline{{m}_{i}} = {max}_{q = i = 1 , 2 , … Q} \{ {m}_{i , q} \} for i = 1 , 2 , … , I \qquad Eq . ( 6 )$$

where I is the number of available channels, i is the channel index, Q is the number of antenna elements, and q is the antenna index.

It should be noted that there are many ways of assigning an overall channel metric to each of the available channels. In other embodiments for example, the overall channel metric for each of the available channels is assigned as the average of the antenna channel metrics for each of the available channels. Thus, in several embodiments, the overall channel metric \overline{mᵢ} for an available channel i is defined as follows:

$$\overline{{m}_{i}} = \frac{1}{Q} {\sum }_{q = 1}^{Q} {m}_{i , q} for i = 1 , 2 , … , I \qquad Eq . ( 7 )$$

where I is the number of available channels, i is the channel index, Q is the number of antenna elements, and q is the antenna index.

After assigning the overall channel metrics for all the available channels, the DCS module 742 proceeds by sorting the plurality of available channels according to their respective overall channel metrics (Step 808 of FIG. 8) in ascending order.

Mathematically, the set of unsorted available channels may be represented by \overline{UM}{I} which denotes a vector of unsorted overall channel metrics defined as: \overline{UM}{I}=[\overline{m₁}, \overline{m₂}, \overline{m₃} . . . \overline{mᵢ}] where I is the number of available channels. After sorting, the set of sorted channels by be represented by \overline{CM}{I} which denotes a sorted overall channel metric vector of size I, where elements of the \overline{CM} vector are the individual overall channel metrics \overline{mᵢ}'s in ascending order, i.e., \overline{CM}{I}=sort(\overline{UM}{I}), and \overline{CM}[1]≦\overline{CM}[2]≦ . . . \overline{CM}[I]. Therefore, in this embodiment, \overline{CM}[1] is the minimum overall channel metric of the available channels, and \overline{CM}[I] is the maximum overall channel metric of the I available channels. Also a channel index vector, CI{I}, of size I is defined where \overline{CM}[i]=\overline{UM}[CI[i]], i=1,2, . . . I. Thus, CI[1] is the available channel having the minimum overall channel metric, and CI[I] is the available channel having the maximum overall channel metric.

In several embodiments, when there is more than one available channel having the minimum overall channel metric, a randomization process is utilized to randomly assign one of the available channels having the minimum overall channel metric with the CI[1] channel index. This randomization process is carried out in the same manner as the single preselected antenna embodiments detailed with reference to FIGS. 3A, 3B and 4. However, in the present embodiments, the randomization process is utilized when there is more than one channel having the same minimum overall channel metric (based upon channel metrics for each antenna) for each available channel instead of performing the randomization process when more than one available channel have the same minimum single channel metric (based upon a single preselected antenna) as described in FIGS. 3A, 3B and 4.

After the available channels are sorted by their respective overall channel metrics, the process of selecting an available channel is carried out in the same manner as the embodiments detailed with reference to FIGS. 3A, 3B and 4. However, in the present embodiments, the overall channel metric (based upon channel metrics for each antenna) for each available channel is utilized in the DCS algorithm to select an available channel instead of a single channel metric from a preselected antenna for each available channel as described in FIGS. 3A, 3B and 4.

Thus, after the available channels are sorted, the DCS module 742 determines whether the overall channel metric of an available channel having the lowest overall channel metric of the available channels, i.e., \overline{CM}[1], is greater than an upper threshold (STEP 810 of FIG. 8). In several embodiments, Step 810 of FIG. 8 is not performed or the threshold is ignored and the DCS module 742 continues to analyze the available channels without comparing it to a threshold. In other embodiments, a retry counter r is defined and set to zero when the DCS algorithm initiates. After determining overall channel metrics for each available channel, if the minimum overall channel metric, i.e., \overline{CM}[1], is above an upper threshold and the retry counter is less than R, the DCS process is restarted again, i.e., the available channels will be probed again (Step 802 of FIG. 8). This will be repeated up to R times, and if the minimum overall channel metric is still above the upper threshold, the available channel with the minimum overall channel metric will be selected. In systems incorporating the rate and power control (RPC) algorithm, there is an increased possibility that the RPC process will result in acceptable interference levels in the system.

Next, whether or not Step 810 of FIG. 8 is performed, a determination is made as to whether co-channel signaling (also generically referred to as other signaling) is present on CI[1] . Co-channel signaling refers to other communications received on the available channel CI[1], not generated by the receiver 700 and the terminals it is intended to communicate with. These other signals may be any other communication burst from another transmitter in the vicinity. As described above, the co-channel signaling is signaling that is highly correlated with signaling of the present system. The co-channel signaling represent a co-channel interference that typically cannot be removed in the baseband processing as opposed to adjacent channel interference. Thus, a determination is made as to whether co-channel signaling is present on the available channel having the lowest overall channel metric (i.e. CI[1]) of the available channels. (Step 812 of FIG. 8).

In one embodiment, preamble detectors 736, 740 (also referred to generically as co-channel signal detectors) provide an indication, e.g., a signal, to the DCS module 742 when a PHY preamble (or other co-channel signal) is detected on available channel CI[1]. In this embodiment, two received signaling samples from two particular antennas are provided through the antenna selector 716 and through the tuner 718 to the RF/IF downconverters 722, 724 . The two received signaling samples are then converted to two intermediate frequency signaling samples by the RF/IF downconverters 722, 724 . In this embodiment, the baseband downconverter portions 726, 728 are each coupled to a respective IF output of the RF/IF downconverters 722, 724 . The baseband downconverter portions 726, 728 each convert one of the two intermediate frequency signaling samples from respective RF/IF downconverters 722, 724 to baseband. The baseband downconverter portions 726, 728 then each provide a baseband signal to a respective A/D converter 756, 758 . The A/D converters each digitize the respective baseband signals and provide respective digitized baseband signals to the preamble detectors 736, 738 . Then each of the preamble detectors 736, 740 determines whether a preamble or other interfering co-channel signal is present in the signaling. If a preamble is not detected, the available channel having the lowest overall channel metric is chosen for communications since the detected signal is non-interfering.

If there is no co-channel signaling present on the available channel having the lowest overall channel metric (Step 814 of FIG. 8), then the available channel having the lowest overall channel metric is selected for communications (Step 816 of FIG. 8). This selection is made because when there is no co-channel signaling on the available channel having the lowest overall channel metric (i.e., available channel CI[1]) no other available channel will have a level of interference that can be reduced below the level of interference present on CI[1].

If co-channel signaling is detected on the available channel having the lowest overall channel metric (Step 814 of FIG. 8) (e.g., a PHY preamble is detected on CI[1]), then a comparison of the overall channel metric of the available channel having the lowest overall channel metric with an overall channel metric of a available channel having a higher overall channel metric is made (Step 818 of FIG. 8).

In several embodiments, e.g., in systems that utilize a PHY preamble, if a PHY preamble is detected on available channel CI[1], then CI[1] is compared with other available channels starting from available channel CI[2]. In these embodiments, if all the other available channels have overall channel metrics that are greater than the overall channel metric of CI[1] by more than a prescribed threshold (Step 820 of FIG. 8)(e.g., 10-15 dB), then CI[1] is selected as an available channel for communications (Step 822 of FIG. 8).

If, however, there are other available channels that do not have co-channel signaling on them (i.e., their overall channel metrics are likely due to adjacent channel signal activity) and the signal activity on these other available channels is no greater than the signal activity on CI[1] by more than the prescribed threshold (Step 820 of FIG. 8), then CI[1] is no longer the best candidate. Thus, in several embodiments, the DCS algorithm determines whether co-channel signaling is present on the available channel having a higher overall channel metric (Step 824 of FIG. 8) than CI[1].

In one embodiment, the determination of whether co-channel signaling is present on an available channel having a higher overall channel metric than CI[1] involves the DCS algorithm determining, beginning with available channel CI[2] and proceeding in order to the other available channels, whether co-channel signaling is present on each of the available channels having an overall channel metric greater than CM[1]. Once a particular available channel is found that does not have co-channel signaling present on it (and the particular available channel has signal activity that is no stronger than the signal activity of CI[1] by no more than the prescribed threshold) that particular available channel is selected for communications. As described above, the co-channel signaling is interfering signaling that is highly correlated with signaling of the present system. In several embodiments, the determination as to whether co-channel signaling is present on other available channels having a higher overall channel metric than CI[1] comprises a determination as to whether a PHY preamble is present on the available channels having higher overall channel metrics. In one embodiment, this determination is made in the same way the determination is made as to whether a preamble is present on channel CI[1] as discussed above. Thus, the DCS module 742 receives a signal from the preamble detectors 736, 740 of FIG. 7A when there is a PHY preamble present on the available channels having higher overall channel metrics (i.e. the DCS module obtains an indication whether co-channel signaling is present on an available channel having a higher overall channel metric than CI[1].)

If all the other available channels having an overall channel metric greater than CI[1] have co-channel signaling on them, then the DCS algorithm selects the available channel with minimum interference, i.e., channel CI[1], regardless of any co-channel signaling present on CI[1]. Thus, the DCS algorithm selects a channel for communications based upon whether the co-channel signaling is detected on the available channel having the higher overall channel metric (Step 826 of FIG. 8)(i.e., a higher overall channel metric than CI[1]).

Thus, according to one embodiment, the DCS algorithm selects an available channel for communications based upon one or more of the following criteria: (a) whether the co-channel signaling is present on the available channel having the lowest overall channel metric; (b) the difference between the available channel having the lowest overall channel metric and the available channel having a higher overall channel metric; and (c) whether the co-channel signaling is detected on the available channel having a higher overall channel metric.

In several embodiments, the DCS algorithm for multiple receive antennas is applied both to provide an Initial DCS (IDCS) at the time during which the AP is powered-up, and to provide Ongoing DCS (ODCS) during the AP operation. When the ODCS algorithm is engaged, all terminals stop communicating so that received signal strength measurements may again be taken, and the same process for selecting one of the available channels is carried out as discussed above. The reasons for the ODCS process to engage may be high error rates, a large number of cyclic redundancy check (CRC) errors, or retransmissions. One or a collection of these parameters may be used at the AP to decide whether the AP should enter the DCS mode again to find a better available channel to avoid further deterioration of the system throughput in the immediate future.

In some embodiments, the DCS operation will be entirely handled by the AP, and no assistance will be provided by the RTs for the ODCS process. In other embodiments, however, provisions in the media access control (MAC) design may be made to facilitate the participation of RTs in the ODCS process to assist the AP in finding the best available channel to move to. In such an embodiment, the AP delegates to the RT the process of making measurements on other available channels. The RT then sends a report back to the AP at the end of the measurement process. During this time, the AP will not schedule any traffic to this delegated RT. This kind of DCS process is denoted as RT Assisted DCS (RADCS). Thus, it should be recognized that the steps of the DCS algorithm need not be carried out solely by elements of the AP and may be performed by other components of the communication system.

It is noted that Steps 808 though 826 may be performed as described in Steps 406-424 of FIG. 4 above, however, the channel metric of FIG. 4 is replaced with the overall channel metric in FIG. 8.

Referring next to FIG. 7B, shown is a functional block diagram of several components of another embodiment of the receiver of FIG. 7A which according to several embodiments of the invention, implements the dynamic channel selection algorithm for selecting one of many available channels for communications with other communication terminals.

Shown is a receiver 750 including the antennas 702, 704, 706, 708, 710, 712, a radio frequency to baseband frequency integrated circuit device 762 (hereinafter referred to as the RF/BB IC device 762) that comprises the antenna selector 716; the tuner 718; radio frequency to baseband frequency downconverters 752, 754 (hereinafter referred to as RF/BB downconverters 752, 754); the analog to digital (A/D) converters 756, 758; the multiplexer 760; the auxiliary analog to digital (A/D) converter 762; and the Analog Received Signal Strength Indication (ARSSI) portions 730, 731 (also referred to as the received signal strength modules 730, 731). Also shown is the baseband integrated circuit device 732 (also referred to as the baseband IC device 732) that comprises the demodulators 734, 738; the preamble detectors 736, 740 (also referred to generically as the “co-channel signal detectors”); and the dynamic frequency selection module 742 (also referred to as the DCS module 742). Additionally shown is the channel select signal 744 that couples the DCS module 742 and the tuner 718 and an antenna select signal 746 that couples the DCS module 742 and the antenna selector 716.

The receiver 750, in several embodiments, operates in much the same way as the receiver 700; however, the signals from the tuner 718 are received by the RF/BB downconverters 752, 754 and converted directly to a baseband frequency instead of being converted to an intermediate frequency. Thus, in the present embodiment, the RF/BB downconverters 752, 754 provide their respective signals at baseband frequency to the respective received signal strength modules 730, 731 where received signal strength measurements are taken of the signals at baseband frequency instead of at an intermediate frequency. Thus, receiver 750 may be referred to as a zero IF receiver.

Another difference between the receiver 700 and the receiver 750 is that the baseband signals from the RF/BB downconverters 752, 754 are provided directly to the A/D converters 756, 758. Thus, in the present embodiment, baseband signals from the RF/BB downconverters 752, 754 are provided to the respective A/D converters 756, 758 where the baseband signals are digitized. The digitized baseband signals from the A/D converters 756, 758 are then provided to the respective preamble detectors 736, 740 where the determination as to whether co-channel signaling is present on a particular channel is made in accordance with the steps set forth in FIG. 4.

It should be noted that many of the functional blocks of the receivers 700, 750 of FIGS. 7A and 7B may be implemented as a set of instructions that are performed in dedicated hardware, firmware or in software using a processor or other machine to execute the instructions to accomplish the provided functionality. For example, in one embodiment, the receivers 700, 750 of FIGS. 7A and 7B may be implemented as one or more integrated circuit (IC) devices.

For example, in one embodiment, the antennas 702, 704, 706, 708, 710, 712, the antenna selector 716, the tuner 718, the RF/IF downconverters 722, 724, the IF to baseband downconverters 726, 728, the analog to digital (A/D) converters 756, 758, the multiplexer 760; the auxiliary analog to digital (A/D) converter 762, and the received signal strength modules 730, 731 are implemented on the RF/IF IC device 714, while the remaining functional components of the receiver, including the DCS module 742 are implemented on the baseband IC device 732, which is coupled to the RF/IF IC device 714.

In another embodiment, implemented according to a zero IF architecture, e.g., the embodiment of FIG. 7B, the antennas 702, 704, 706, 708, 710, 712, the antenna selector 716, the tuner 718, the RF/BB downconverters 752, 754, the analog to digital (A/D) converters 756, 758, the multiplexer 760; the auxiliary analog to digital (A/D) converter 762, and the received signal strength modules 730, 731 are implemented on the RF/BB IC device 762, while the remaining functional components of the receiver, including the DCS module 742 are implemented on the baseband IC device 732, which is coupled to the RF/BB IC device 762.

These integrated circuit devices 714, 762 and 732 may be referred to application specific integrated circuits (ASICs) or generically as chips. Alternatively, the RF/IF IC device 714, the RF/BB IC device 762 and the baseband IC device 732 may be implemented as a single chip or ASIC. Thus, the RF/IF IC device 714, the RF/BB IC device 762 and the baseband IC device 732 may be a part of a chipset or a single chip or ASIC designed to implement the function blocks of the receivers 700, 750. Similarly, the steps of FIG. 8 may be performed as a set of instructions that are performed in dedicated hardware, firmware or in software using a processor or other machine to execute the instructions to accomplish the given steps.

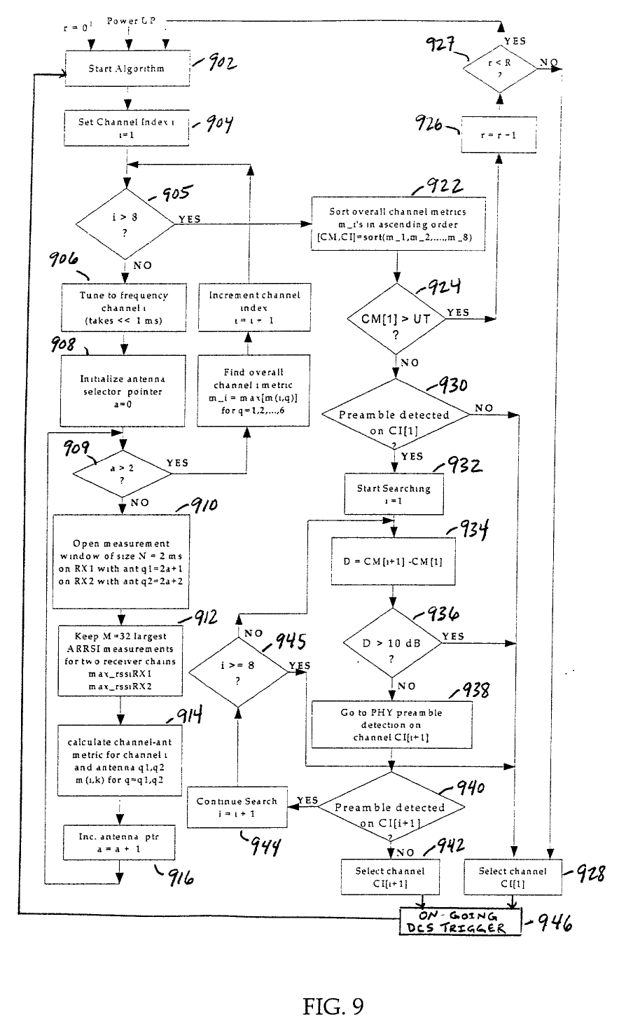

Referring next to FIG. 9, shown is a flowchart illustrating the steps performed by the access point of FIG. 7A or FIG. 7B in implementing the DCS algorithm in accordance with one embodiment of the present invention.

As with the embodiment detailed with reference to FIG. 5, in the present embodiment, eight nominal carrier frequencies are available in a frequency band from 5150 MHz to 5350 MHz; thus, in the present embodiment, the available channels are eight available frequency channels (i.e., I=8). In the present embodiment, however, Q receive antennas (e.g., six receive antennas) are present for the receiver 700 (e.g., antennas 702 through 712 of FIG. 7), and the receiver has n (where n≧1) receiver chains (e.g., two receiver chains including receiver chain #1 and receiver chain #2 as described with reference to FIG. 7); thus allowing n antennas to be selected (e.g., by the antenna selector 716) and sampled at the same time (e.g., by the received signal strength modules 730, 731).

In the present embodiment, the Dynamic Channel Selection (DCS) mechanism is employed to avoid occupied frequency channels at the power-up and to ensure a uniform spreading of 5 GHz devices over all the available channels. As discussed, Ongoing DCS ensures that the best operating channel is used with the minimum level of interference during the entire operation of the AP. Thus, in the present embodiment, DCS operation initially avoids occupied frequency channels that have a high level of interference at the power-up, and Ongoing DCS minimizes the interference in the system by moving to the appropriate available channel during the operation of the system. Such operation will support high density deployments for the 5 GHz wireless devices.

In the present embodiment, the DCS algorithm operates to calculate channel metrics for each antenna over a particular available channel in much the same way as the DCS algorithm in the embodiments described with reference to FIG. 5 calculate channel metrics for each available channel. In the present embodiment, however, an overall channel metric (based upon channel metrics for each antenna) for each available channel is utilized in the DCS algorithm to select an available channel instead of a single channel metric from a single antenna for each available channel as described in FIG. 5.

In the present embodiment, upon power-up, the DCS algorithm is started (Step 902), and an available channel index i is set to 1 (Step 904). If the channel index i is not greater than eight (Step 905), an available channel is selected by tuning (e.g., with the tuner 718 of FIG. 7) to that available channel (Step 906), and an antenna selector pointer a is initialized to equal zero (Step 908).

If the antenna selector pointer a is less than or equal to two (Step 909), received signal strength measurements for the first available channel are taken two antennas at a time utilizing two receiver chains (e.g., receiver chain #1 and receiver chain #2 as described with reference to FIG. 7). In one embodiment, these measurements are taken by opening a DCS measurement window of size N=2 ms on a first receiver chain (e.g. receiver chain #1 as described with reference to FIG. 7) with a first antenna (e.g., antenna 702) denoted by q₁=2a+1 and by opening a measurement window of size N=2 ms on a second receiver chain (e.g. receiver chain #2 as described with reference to FIG. 7) with a second antenna (e.g. antenna 704) denoted by q₂=2a+2 (Step 910).

During the measurement window, the received signal strength measurements taken over each antenna (for the first available channel) may be either utilized (e.g., by the DCS module 742 of FIG. 7) as discrete received signal strength measurements or received signal strength measurements that are an average of a small number (e.g., four) of the discrete received signal strength measurements. Regardless of what type of received signal strength measurement is utilized, the M largest received signal strength measurements for each of the two receiver chains are retained (Step 912) (e.g., where in one embodiment M=32). Next, a channel metric for the first antenna and the second antenna over the first available channel is determined by averaging these M largest measurements using equation (5) (Step 914).

After channel metrics are determined for the first and second antennas over the first available channel, the antenna selector pointer a is incremented by 1 (Step 916), and Steps 909 through 916 are repeated until a is greater than 2 (Step 909) at which point channel metrics for all the Q antennas will have been determined over the first available channel. It is noted that other methods may be used to determine the channel metrics for each of Q antennas taken n at a time as described herein. Thus, Steps 909 though 916 represent one embodiment of accomplishing steps 802 and 804 of FIG. 8.

After channel metrics for all the antennas are established over the first available channel, an overall channel metric is assigned to the first available channel using Equation (6) (Step 918). Thus, an overall channel metric equal to the maximum of the channel metrics of the antennas (for the first available channel) is established for the first available channel.

Next, the available channel index i is incremented by one (Step 920), and Steps 905 through 920 are repeated until until i>I (e.g., until i>8) (Step 905) so that each of the eight available channels is assigned an overall channel metric. It is noted that other methods may be used to determine the overall channel metric for each available channel as described herein. Thus, Step 918 is one embodiment of accomplishing Step 806 of FIG. 8.

After gathering the overall channel metrics for all the eight available channels (in the 5150-5350 MHz band), the DCS algorithm proceeds by sorting the available channels by their overall channel metrics in ascending order (Step 922).

Next, the DCS algorithm compares the \overline{CM}[1] element, which is the available channel with the minimum overall channel metric (which is also referred to as the QUIETEST channel, among all the eight channels) against an upper threshold (UT) (Step 924). If the signal activity in the QUIETEST channel is above the upper threshold, essentially that means none of the available channels is really “interference free enough” to be selected, and in one embodiment, a retry counter r ( that is set to zero upon initiation of the DCS algorithm) is incremented by one (Step 926). If the retry counter is less than a predetermined maximum number of attempts R (Step 927), the DCS process is restarted again (Step 902), i.e., the available channels will be probed again. The Steps of 902 though 927 will be repeated up to R times, and if this event happens again (i.e. the QUIETEST channel has an overall channel metric greater than an upper threshold (Step 924 and 927)), the available channel with the minimum overall channel metric will be selected (Step 928).

If \overline{CM}[1] is not greater than the upper threshold (UT) (Step 924), then a determination is made as to whether a PHY preamble (i.e., one example of an interfering co-channel signal) can be detected on available channel CI[1] (Step 930), i.e., it is determined if co-channel signaling is present on CI[1]. If a preamble is not detected (Step 930), it means that, probably this is not a co-channel signal (but there might be a non 802.11a device in the same band), and available channel CI[1] is selected (Step 928).

If a PHY preamble is detected on the first available channel CI[1] (Step 930), then the DCS algorithm starts searching for an available channel having a higher overall channel metric with an acceptable level of interference that does not have a preamble detected on it (Step 932).

The first step in the search for such an available channel is to compare available channel CI[1] with the other available channels starting from available channel CI[2] by subtracting \overline{CM}[1] from \overline{CM}[2] (Step 934). The next test is to check whether signal activity in available channel CI[2] is stronger than signal activity in available channel CI[1] by more than a threshold of approximately 10 dB (Step 936). If \overline{CM}[2]−\overline{CM}[1]>10 dB (Step 936) available channel CI[1] is selected (Step 928). This is because even though the source of interference on CI[1] is a co-channel signal and the source of interference in CI[2] was due to adjacent channel signal, the baseband filtering cannot further reduce the interference on CI[2] below that of \overline{CM}[1].

If \overline{CM}[2] is not greater than \overline{CM}[1] by more than about 10 dB (Step 936), then a determination is made as to whether a preamble exists on CI[2] (Steps 938 and 940). If a preamble is not detected in available channel CI[2], then CI[2] is selected (Steps 942). Otherwise, if a preamble is detected on available channel CI[2] (Step 940), the channel index i is incremented by 1 and the search continues by incrementing the channel index (Step 944) to find an available channel without co-channel signaling that has signal activity that is not greater than about 10 dB more than that of CI[1]. This continuing search involves repeating Steps 934 through 945 as necessary while the channel index i less than eight (Step 945). If all available channels are exhausted and still no available channel is selected (i.e., the channel index i is greater than or equal to eight (Step 945)), the DCS algorithm selects the available channel with minimum interference, available channel CI[1] (Step 928).

Once an available channel is selected, the DCS algorithm continues to monitor the communications taking place for a DCS triggering event as part of an Ongoing DCS (ODCS) operation (Step 946). Potential DCS triggering events include high error rates, a large number of CRC errors, or retransmissions. One or a collection of these parameters may be used at the AP to trigger the start of the DCS algorithm again (Step 902) to find a better available channel to avoid further deterioration of the system throughput in the immediate future.

The steps of the DCS algorithm shown with reference to FIG. 9 in several embodiments are handled by the AP, without assistance from the RTs. In other embodiments, however, provisions may be made in MAC design to facilitate the participation of RTs in the ODCS process to assist the AP in finding the best available channel to move to. In such a case, the AP will give delegation to the RT to go and make measurements on other available channels and send a report back to the AP at the end of the measurement process. During this time, the AP will not schedule any traffic to this delegated RT. Such a process may be referred to as RT Assisted DCS (RADCS).

It is noted that the steps listed in FIG. 9 generally represent the steps in performing the DCS algorithm according to several embodiments of the invention. These steps may be performed by the DCS module 742 of FIG. 7A or FIG. 7B and/or may be performed as a set of instructions that are performed in dedicated hardware, firmware or in software using a processor or other machine to execute the instructions to accomplish the given steps.

It is also noted that one of ordinary skill in the art is readily able to adapt the steps of FIG. 9 (directed to frequency channel selection) to apply to the selection of other types of available channels, e.g., time channels and/or code channels. For example, in one embodiment, Steps 904, 905, 906, and 910 are varied depending on the type of channel being selected.

While the invention herein disclosed has been described by means of specific embodiments and applications thereof, numerous modifications and variations could be made thereto by those skilled in the art without departing from the scope of the invention set forth in the claims.

What is claimed is:

1. A method for selecting between available channels comprising:
determining a channel metric corresponding to measurements taken at a receiver for each of a plurality of available channels, the channel metric indicative of a level of interference in each of the plurality of available channels;
sorting the plurality of available channels according to their respective channel metric;
determining whether co-channel signaling is present on an available channel having a lowest channel metric of the plurality of available channels; and
selecting one of the plurality of available channels based upon at least the determining whether the co-channel signaling is present on the available channel having the lowest channel metric.

2. The method of claim 1 wherein the step of determining whether the co-channel signaling is present on the available channel having the lowest channel metric comprises determining whether a preamble is present on the available channel having the lowest channel metric.

3. The method of claim 1 further comprising:
comparing, in the event that the co-channel signaling is present on the available channel having the lowest channel metric, the channel metric of the available channel having the lowest channel metric with a channel metric of an available channel having a higher channel metric;
wherein the step of selecting comprises selecting the one of the plurality of available channels based upon a difference between the channel metric of the available channel having the lowest channel metric and the channel metric of the available channel having the higher channel metric.

4. The method of claim 3 further comprising:
determining whether co-channel signaling is present on the available channel having a higher channel metric;
wherein the step of selecting comprises selecting the one of the plurality of available channels based upon whether the co-channel signaling is detected on the available channel having the higher channel metric.

5. The method of claim 4 wherein the step of determining whether the co-channel signaling is present on the available channel having the higher channel metric comprises determining whether a preamble is present on the available channel having the higher channel metric.

6. The method of claim 1 further comprising:
determining, in the event the co-channel signaling is present on the available channel having the lowest channel metric, whether co-channel signaling is present on an available channel having a higher channel metric;
wherein the step of selecting comprises selecting the one of the plurality of available channels based upon whether the co-channel signaling is detected on the available channel having the higher channel metric.

7. The method of claim 6 wherein the step of determining whether the co-channel signaling is present on the available channel having the higher channel metric comprises determining whether a preamble is present on the available channel having the higher channel metric.

8. The method of claim 1 comprising:
re-determining, in the event the available channel having the lowest channel metric is greater than a threshold, another channel metric for each of the plurality of available channels.

9. The method of claim 1 wherein the step of determining the channel metric for each of the plurality of available channels comprises:
receiving a plurality of received signal strength measurements corresponding to L discrete received signal strength measurements taken at an antenna of the receiver within a time period of a measurement window for each of the plurality of available channels;
retaining a quantity of M of the plurality of received signal strength measurements for each of the plurality of available channels, wherein the quantity M is a value up to 25% of L; and
assigning the channel metric denoted by mᵢ to each of the plurality of available channels equal to:
$${m}_{i} = \frac{1}{M} {\sum }_{j = 1}^{M} ARRSI [ j ] i = 1 , 2 , … , I$$
where ARRSI[j] is one of the received signal strength measurements, j is a received signal strength measurement index, i is an available channel index, and where i=1,2,3 . . . I, where I is a quantity of the plurality of available channels.

10. The method of claim 9 wherein the step of retaining comprises retaining the quantity of M received signal strength measurements from a set of the highest of the plurality of received signal strength measurements for each of the plurality of available channels.

11. A channel selection device for a communication terminal of a communication system comprising:
a dynamic channel selection module configured to perform the following steps:
determining a channel metric corresponding to measurements taken at a receiver for each of a plurality of available channels, the channel metric indicative of a level of interference in each of the plurality of available channels;
sorting the plurality of available channels according to their respective channel metric;
obtaining an indication whether co-channel signaling is present on an available channel having a lowest channel metric of the plurality of available channels; and
selecting one of the plurality of available channels based upon at least the determining whether the co-channel signaling is present on the available channel having the lowest channel metric.

12. The device of claim 11 further comprising an integrated circuit device, the dynamic channel selection module implemented within the integrated circuit device.

13. The channel selection device of claim 11 wherein the dynamic channel selection module is additionally configured to perform the following step:
comparing, in the event that the co-channel signaling is present on the available channel having the lowest channel metric, the channel metric of the available channel having the lowest channel metric with a channel metric of an available channel having a higher channel metric;
wherein the step of selecting comprises selecting the one of the available channels based upon the difference between the channel metric of the available channel having the lowest channel metric and the channel metric of available the available channel having the higher channel metric.

14. The channel selection device of claim 13 wherein the dynamic channel selection module is additionally configured to perform the following step:
obtaining an indication whether co-channel signaling is present on the available channel having a higher channel metric;
wherein the step of selecting comprises selecting the one of the available channels based upon whether the co-channel signaling is detected on the available channel having the higher channel metric.

15. The channel selection device of claim 11 wherein the dynamic channel selection module is additionally configured to perform the following step:
determining, in the event that the co-channel signaling is present on the available channel having the lowest channel metric, whether co-channel signaling is present on the available channel having the higher channel metric;
wherein the step of selecting comprises selecting the one of the available channels based upon whether the co-channel signaling is detected on the available channel having the higher channel metric.

16. A channel selection device for a communication terminal of a communication system comprising:
means for determining a channel metric corresponding to measurements taken at a receiver for each of a plurality of available channels, the channel metric indicative of a level of interference in each of the plurality of available channels;
means for sorting the plurality of available channels according to their respective channel metric;
means for obtaining an indication whether co-channel signaling is present on an available channel having a lowest channel metric of the plurality of available channels; and
means for selecting one of the plurality of available channels based upon at least the determining whether the co-channel signaling is present on the available channel having the lowest channel metric.

17. The device of claim 16 further comprising:
means for comparing, in the event that the co-channel signaling is present on the available channel having the lowest channel metric, the channel metric of the available channel having the lowest channel metric with a channel metric of an available channel having a higher channel metric;
wherein the means for selecting comprises selecting the one of the plurality of available channels based upon a difference between the channel metric of the available channel having the lowest channel metric and the channel metric of the available channel having the higher channel metric.

18. The device of claim 17 further comprising
means for determining whether co-channel signaling is present on the available channel having a higher channel metric;
wherein the means for selecting comprises means for selecting the one of the available channels based upon whether the co-channel signaling is detected on the available channel having a higher channel metric.

19. The device of claim 16 further comprising:
means for determining whether co-channel signaling is present on an available channel having a higher channel metric;
wherein the means for selecting comprises means for selecting the one of the available channels based upon whether the co-channel signaling is detected on the available channel having the higher channel metric.

20. The device of claim 16 further comprising:
means for receiving a plurality of received signal strength measurements corresponding to L discrete received signal strength measurements taken at an antenna of the receiver within a time period of a measurement window for each of the plurality of available channels;
means for retaining a quantity of M of the plurality of received signal strength measurements for each of the plurality of available channels, wherein the quantity M is a value up to 25% of L; and
means for assigning the channel metric denoted by mᵢ to each of the plurality of available channels equal to:
$${m}_{i} = \frac{1}{M} {\sum }_{j = 1}^{M} ARRSI [ j ] i = 1 , 2 , … , I$$
where ARRSI[j] is one of the received signal strength measurements, j is a received strength measurement index, i is an available channel index, and where i=1,2,3 . . . I, where I is a quantity of the plurality of available channels.

21. The method of claim 20 wherein the means for retaining comprises means for retaining the quantity of M received signal strength measurements from a set of the highest of the plurality of received signal strength measurements for each of the plurality of available channels.

22. A method for selecting between available channels comprising:
receiving a plurality of received signal strength measurements corresponding to L discrete received signal strength measurements taken at an antenna within a time period of a measurement window for each of a plurality of available channels;
retaining a quantity of M of the plurality of received signal strength measurements for each of the plurality of available channels, wherein the quantity M is a value up to 25% of L; and
assigning a channel metric denoted by mᵢ to each of the plurality of available channels equal to:
$${m}_{i} = \frac{1}{M} {\sum }_{j = 1}^{M} ARRSI [ j ] i = 1 , 2 , … , I$$
where ARRSI[j] is one of the M received signal strength measurements, j is a received signal strength measurement index, i is an available channel index, and where i=1,2,3 . . . I, where I is a quantity of the plurality of available channels.

23. The method of claim 22 wherein the retaining step comprises retaining a quantity of M largest of the plurality of received signal strength measurements for each of the plurality of available channels.
